(19) United States
(12) Patent Application Publication
(10) Pub. No.: US 2003/0093433 A1
(43) Pub. Date: May 15, 2003

(54) Method and system for software application development and customizible runtime environment

(75) Inventors: Christopher G. Seaman, South Jordan, UT (US); Bruce Alan James, Salt Lake City, UT (US); Steven J. Quinn, Farmington, UT (US); Paul F. Dorius, Park City, UT (US); Scott T. Petersen, Fruit Heights, UT (US); Keven D. Miller, Orem, UT (US)

Correspondence Address: Lloyd W. Sadler, Parsons Behle & Latimer, Suite 1800, 201 South Main Street, Salt Lake City, UT, 84111, US

(73) Assignee: Exegesys, Inc., Salt Lake City, UT

(21) Appl. No.: 10/298,022

(22) Filed: Nov. 14, 2002

Related U.S. Application Data
(60) Provisional application No. 60/332,345, filed on Nov. 14, 2001.

(51) Int. Cl. G06F 7/00

(52) U.S. Cl. 707/102

(57) ABSTRACT

A method and system for developing customizable computer application programs, which can be customized without modification of said original application source code. This invention facilitates operation of computer application programs with a wide variety of computer operating systems, computer hardware, and computer databases as well as providing access through a variety of familiar user interfaces.

### CROSS REFERENCE TO RELATED APPLICATIONS

This application claims priority to co-pending, co-owned U.S. Provisional Patent Application No. 60/332,345, filed on Nov. 14, 2001.

### BACKGROUND OF INVENTION

1. Field of the Invention

This invention relates to computer software application development environments. More specifically, this invention relates to software application development environments that facilitate customization of computer code to meet special requirements of particular software users.

2. Description of Related Art

A variety of computer software development tools and environments are well known in the art. Typical of these prior tools and environments is the Microsoft Visual Studio suite of program application development tools. However, such prior systems do not provide a general, cross-platform, cross-database, development architecture that can be used to efficiently create prepackaged customizable application software. Moreover, traditional software is designed and developed in such a manner that all data definitions must be defined within the source code for each individual program. These data definitions include screen definitions, database table definitions, internal data storage buffers, and other data elements. If these definitions need to change, because of errors, improvements or customization, the source code must be modified and the program recompiled. In some instances, copy libraries and include files have simplified the process of changing these definitions, but the process of recompiling the programs after a change has remained. In some cases, in order to avoid the need to modify the source code and therefore having to recompile, programmers have begun to attempt to anticipate the types of changes that customers may want to make and have actually tried to include the code for the anticipated functionality into the application program initially. They then use software switches or parameters to enable or disable those functions.

The applicants' present invention is distinguished from these prior techniques by features and capabilities that include, but are not necessarily limited to, moving data definitions to a location external to the source code and by providing a library of functions adapted to allow data definitions to change without causing the source code to have to change.

The following U.S. Patents, each of which is hereby incorporated by reference in its entirety for the material contained therein, are referred to the reader for general background material.

U.S. Pat. No. 5,021,947 describes a data-flow architecture and software environment for high-performance signal and data processing.

U.S. Pat. No. 5,179,702 describes an integrated software architecture for a highly parallel multiprocessor system having multiple tightly-coupled processors that share a common memory to control the interface and execution of programs on such a multiprocessor system.

U.S. Pat. No. 5,233,513 describes a microprocessor manipulated program, which extracts the data inherent in the cognitive process leading to the spoken or written word and converts that data into business models capable of defining the interrelationship and functions of a business.

U.S. Pat. No. 5,374,932 describes an airport surface traffic surveillance and automation system.

U.S. Pat. No. 5,412,756 describes an artificial intelligence software shell for plant operation simulation that includes a blackboard module, including a database having objects representing plant elements and concepts.

U.S. Pat. No. 5,457,797 describes a method of partitioning an application program by defining an application program for execution on at least two interconnected computers, selected from at least two classes of computers without considering what specific machine environment will be used as run time.

U.S. Pat. No. 5,487,141 describes a relational database management system with an object-based, interactive visual-programming language that provides programming by “visual inheritance.”

U.S. Pat. No. 5,519,618 describes an airport safety logic system that includes a target state machine, a prediction engine, light-control logic and alert logic.

U.S. Pat. No. 5,539,869 describes a method and system for processing and presenting on-line, multimedia information such as diagnostic information for a machine tool.

U.S. Pat. No. 5,565,316 describes a system and method for computer based testing.

U.S. Pat. No. 5,570,270 describes a computer and a chassis construction for a severe environmental conditions.

U.S. Pat. No. 5,579,520 describes a development system having a compiler, a linker, an interface, and a code packing optimization module.

U.S. Pat. No. 5,590,331 describes a method and apparatus for generating a platform-standard object file that contains machine-independent abstract code.

U.S. Pat. No. 5,600,789 describes a method for automated testing of both new and revised computer application programs, which use a Graphical User Interface.

U.S. Pat. No. 5,623,591 describes an electronic spreadsheet system that includes a notebook interface having a plurality of notebook pages, each of which may contain a spread of information cells, or other desired page type.

U.S. Pat. No. 5,628,016 describes a development system having a compiler that allows programmers and software developers to more efficiently develop a compiled application with runtime exception handling support.

U.S. Pat. No. 5,630,125 describes an apparatus and method for an information management system, that includes an Application Generator and a Retrieval system.

U.S. Pat. No. 5,651,108 describes a development system that includes a relational database management system (RDBMS), having an object-based, interactive visual-programming language providing programming by “visual inheritance.”

U.S. Pat. No. 5,659,680 describes a PC-based diagnostic system that is modular-based, and includes a motherboard, a backplane board, a PCMCIA board, and a keypad adapter board.

U.S. Pat. No. 5,666,411 describes a system for protecting proprietary software from disclosure and unauthorized use, enforces license limits on the number of users of the software and prevents the corruption of protected software by computer viruses.

U.S. Pat. Nos. 5,590,345, 5,710,935, 5,717,943, and 5,842,031 describe a computer system having a plurality of processors and memory, including a plurality of scalable nodes having a multiple processor-like memory components.

U.S. Pat. No. 5,724,272 describes a method and apparatus for controlling instrumentation systems and for providing a user with the capability of developing instrument drivers and application software for controlling instrumentation systems.

U.S. Pat. No. 5,724,589 describes a development system providing a property-method-event programming model for developing context-free reusable software components.

U.S. Pat. No. 5,781,720 describes a method for automated testing of both new and revised computer application programs, which use a Graphical User Interface (GUI).

U.S. Pat. Nos. 5,432,940, 5,475,843, 5,627,958 and 5,790,117 describes a computer-based training system having one or more Application Translation Units (ATUs), a Message Engine, and a Script Engine.

U.S. Pat. No. 5,802,514 describes a tool for the development of multiple-table database applications for client/server environments that automates both the capture of system requirements and code production.

U.S. Pat. No. 5,812,394 describes an object-oriented development system for developing control schemes for facilities that includes a device diagramming component for describing a physical description of a facility and a logical definition of control scheme for the facility.

U.S. Pat. No. 5,827,070 describes a system and method for computer based testing.

U.S. Pat. No. 5,844,554 describes a computer implemented method of generating a user product configuration program module from a development environment.

U.S. Pat. No. 5,862,373 describes a computer implemented application development system that permits objects to be graphically inserted into the program under development by dragging and dropping associated icons into one of four view.

U.S. Pat. No. 5,883,623 describes an electronic spreadsheet system that includes a notebook interface having a plurality of notebook pages, each of which may contain a spread of information cells, or other desired page type.

U.S. Pat. No. 5,893,125 describes a database system with methodology providing “live” views of a database.

U.S. Pat. No. 5,907,696 describes a method and apparatus for creating the appearance of network device and its communications, and in particular, an SNMP agent and its SNMP communications.

U.S. Pat. No. 5,911,070 describes a development system with visual designer tools for generating and modifying program code.

U.S. Pat. No. 5,933,642 describes a compiling system and method for generating a sequence of program instructions for use in a dynamically reconfigurable processing unit having an internal hardware organization that is selectively changeable among a plurality of hardware architectures, each hardware architecture executing instructions from a corresponding instruction set.

U.S. Pat. No. 5,944,783 describes an apparatus and method for information transfer among software agents operating simultaneously on a digital network.

U.S. Pat. Nos. 5,588,152, 5,625,836, 5,708,836, 5,713,037, 5,717,944, 5,734,921, 5,752,067, 5,754,871, 5,761,523, 5,765,011, 5,794,059, 5,870,619, 5,878,241, 5,963,745, 5,963,746, 5,966,528, and 6,094,715 describe parallel array processors for massively parallel applications.

U.S. Pat. No. 5,978,585 describes a development system that provides a methodology for improving system performance by decreasing recompilation of dependent source modules.

U.S. Pat. No. 5,999,730 describes a utility with a windows interface with which a single original-equipment-manufacturer (OEM) programmer can generate firmware compatible with the Advanced Configuration and Power Interface (ACPI) +specification.

U.S. Pat. No. 6,002,867 describes a visual development system which allows a user to derive forms from other “ancestor” forms, inheriting their components, properties, and code as a starting point for one's own forms.

U.S. Pat. No. 6,014,138 describes a system that includes a relational database management system (RDBMS), having an object-based, interactive visual-programming language that provides programming by “visual inheritance.”

U.S. Pat. No. 6,026,235 describes a development system having a monitor/profiler tool for monitoring functions in a natively compiled software programs.

U.S. Pat. No. 6,049,673 describes a method for implementing a software application by shifting all the definition of an application into data, which need not be translated to code to be run, which is run by code which remains the same from application to application.

U.S. Pat. No. 6,070,165 describes a framework, for use in an object-based application being executed in a digital computing system, for managing information retrieved from a structured database, such as a relational database.

U.S. Pat. No. 6,078,325 describes a computer-based information exchange system that permits customers to request and receive different types of information from various sources.

U.S. Pat. No. 6,078,743 describes a generic IDE interface, for scripting objects in a component software architecture, used to allow connection to a language-specific scripting IDE preferred by a user.

U.S. Pat. No. 6,088,659 describes an automated meter reading (AMR) server having an open, distributed architecture that collects, loads, and manages system-wide data collected from energy meters and routes the data automatically to upstream business systems.

U.S. Pat. No. 6,094,635 describes a computer apparatus and method for adding speech interpreting capabilities to an interactive voice response system.

U.S. Pat. No. 6,102,965 describes a graphical programming development system for creating a graphical program client, wherein the graphical program client is operable to programmatically access or invoke functionality of graphical programming applications or graphical programs.

U.S. Pat. No. 6,115,040 describes an integrated system of user interfaces for communicating with remote services.

U.S. Pat. No. 6,125,383 describes a drug discovery research system, which includes a plurality of computers.

U.S. Pat. No. 6,157,955 describes a general-purpose programmable packet-processing platform for accelerating network infrastructure applications, which have been structured so as to separate the stages of classification and action.

U.S. Pat. No. 6,185,728 describes a visual development system which provides “method pointers” to allow a developer/user to achieve delegation between objects programmatically as well as visually.

U.S. Pat. No. 6,195,676 describes an integrated software architecture for a highly parallel multiprocessor system having multiple tightly-coupled processors that share a common memory to control the interface with and execution of programs on a multiprocessor system.

U.S. Pat. No. 6,199,068 describes a mapper for translating an input file from an input domain to an output domain.

U.S. Pat. No. 6,212,673 describes a method, apparatus and article of manufacture and memory for a component neutral builder interface.

U.S. Pat. No. 6,226,692 describes a system and method for designing and constructing software components and systems by assembling them from independent parts which is compatible with and extends existing object models.

U.S. Pat. No. 6,230,307 describes a method and system for programming the hardware of field programmable gate arrays and related reconfigurable resources as if they were software creating hardware objects that implement application level functionalities, operating system functionalities, and hardware functionalities.

U.S. Pat. No. 6,230,309 describes a design tool for assembling component objects to form an object-based computer system application that includes a declarative user input interface mechanism and a design engine.

U.S. Pat. No. 6,233,726 describes a visual development environment which provides drag-and-drop code editing methodology, using Reference Card and Parameter Wizard methodologies.

U.S. Pat. No. 6,263,492 describes a componentizing object designer that is used to define a componentization of visual forms and other object-oriented technologies.

U.S. Pat. No. 6,289,382 describes a system, method and article of manufacture for delivering service via a globally addressable interface.

### SUMMARY OF INVENTION

It is desirable to provide a method and system for the development of computer application programs that provides for program customization without modification of the original source code and which facilitates operation of the customized computer code with a variety of computer operating systems and Database engines and which uses familiar user interfaces. Accordingly, the various embodiments of this invention accomplish the forgoing and some or all of the following objects.

Therefore, it is an object of this invention to provide a development methodology and system for development of pre-packaged computer software applications that can be customized to meet end user requirements.

It is a further object of this invention to provide a method and system for customizing computer software that provides customization without affecting the original source code.

It is a still further object of this invention to provide a method and system for customizing computer software that is compatible with multiple operating systems.

Another object of this invention is to provide a method and system for customizing computer software that facilitates continued support from the original software provider.

A further object of this invention is to provide a method and system for creating computer software applications that can be easily tailored by the end-user.

A still further object of this invention is to provide a method and system for developing customizable computer software applications that are capable of operating on a variety of computer system architectures.

Another object of this invention is to provide a method and system for developing customizable computer software applications that are compatible with a variety of computer operating systems.

A further object of this invention is to provide a method and system for developing customizable computer software applications that are compatible with a variety of database systems.

A still further object of this invention is to provide a method and system for developing customizable computer software applications that provide a separation between the user interface code, the database access code and the business logic/transaction code.

It is another object of this invention to provide a method and system for developing customizable computer software applications where the developed software can operate in a distributed system environment.

It is a further object of this invention to provide a method and system for developing customizable computer software applications that is compatible with localization and foreign language customization.

It is a still further object of this invention to provide a method and system for developing customizable computer software applications that facilitates the use of multiple transactions.

Another object of this invention is to provide a method and system for developing customizable computer software applications that improves software development efficiency.

These and other objects and advantages of this invention are achieved by the invention as described herein.

### BRIEF DESCRIPTION OF DRAWINGS

The accompanying drawings incorporated in and forming a part of the specification illustrate present preferred embodiments of this invention. Some, although not all, alternative embodiments are described in the following description. In the drawings:

FIG. 1 is a top-level hardware diagram of the typical computer system implementing this invention.

FIG. 2 is a top level functional block diagram of the present embodiment of the invention.

FIG. 3 is a top level functional block diagram of the preferred development environment of the present embodiment of the invention.

FIG. 4 is a top level block diagram of the preferred system of this invention.

FIG. 5 is a diagram showing the available operating system independent functions of the present embodiment of this invention.

FIG. 6 is a diagram of the major portions of the APPDIC database of the present embodiment of this invention.

FIG. 7a is a first object diagram of the general data movement classes.

FIG. 7b is a second object diagram of the general data movement classes.

FIG. 7c is an object diagram of the Unix Daemon/Windows service routines.

FIG. 7d is an object diagram of the Process Handling Routines.

FIG. 7e is an object diagram of the Shared Library Class.

FIG. 7f is an object diagram of the File and Directory Handling.

FIG. 7g is an object diagram of the Message Ports.

FIG. 7h is a first object diagram of the XML Classes.

FIG. 7i is a second object diagram of the XML Classes.

FIG. 7j is an object diagram of the Misc. Classes.

FIG. 8 is a diagram showing the actions and results of the customization process.

FIG. 9a is an object diagram of the Messaging Routines.

FIG. 9b is an object diagram of the Transaction Information Storage.

FIG. 9c is an object diagram of the Transaction Registration Routines.

FIG. 9d is an object diagram of the Application Interface Class.

FIG. 10 is a diagram of the class and memory structures that are used to contain customizable data definitions of the present embodiment of the invention.

FIG. 11a is an object diagram of the Buffer Management.

FIG. 11b is an object diagram of the Fields class.

FIG. 12 is a diagram that shows how the present Dynamic SQL Generator is used based on current data definitions or customization data definition changes.

FIG. 13a is an object diagram of Database Manipulation Routines.

FIG. 13b is an object diagram of the Database Driver Design.

FIG. 14 is a diagram that shows the relationship between the messages contained in the present APPDIC with the internal invention process structures for handling messages.

FIG. 15 is an object diagram of the Exception Handling Classes.

FIG. 16 is a diagram showing the relationship between user interfaces, the Traffic Control System and the runtime process Applications.

FIG. 17 is a block diagram showing the tools layer of the present embodiment of the invention.

FIG. 18 is a flow diagram of the present Traffic Control System of the invention.

FIG. 19 is a flow diagram of the present Application Handler (Driver).

FIG. 20 is a flow diagram of the prep process of the present embodiment of the invention.

FIG. 21 is an object diagram of the LoadAppdic Utility.

FIG. 22 is an object diagram of the AppdicExtract Utility.

FIG. 23 shows a detailed flow chart of the present preferred process of the Makehfile utility of this invention.

FIG. 24 is a detailed flow diagram of the make SRM Builder process of the present embodiment of this invention.

FIG. 25 is an object diagram of the Tester.

Reference will now be made in detail to the present preferred embodiment of the invention, an example of which is illustrated in the accompanying drawings.

### DETAILED DESCRIPTION

The following definitions of terms are provided to assist the reader in understanding this patent disclosure, each of which is inventors terminology as a lexicographer of this application.

Buffer is a collection of fields.

Critical field is a field that must be present in a buffer.

Field is the base data element.

GCS or Grand Central Station is the controlling process for the traffic control system.

Invalid field is a field that is not allowed to be a part of a particular buffer.

Literal is a named constant value, such as “yes” or “no”. Literal values may be localized.

A literal group is a logical grouping of literals, for example, a literal group could consist of “yes” or “no”, or “true” or “false” or “yes” and “no”, or “true” and “false.”The prep (or Preparation Process) process is the process by which design information is compiled and made available to a program using this invention.

SRM stands for System Reference Manual. This is a manual detailing the steps taken in a particular transaction. It describes, at a high level, the flow of the transaction.

Traffic control system is the router that routes all invention communication messages to the correct application program or invention process.

User exit is a point in the code at which an external procedure defined by the end user is called. User exits allow end users to modify the transaction flow.

This invention is a method and system that provides a computer software development environment that facilitates the development, distribution, management, and quality control of computer software application programs that can be customized by the end-user without requiring modification of the original source code. Inherent in this invention is a runtime environment that allows the computer software application programs to be customized by the end-user and facilitates the porting of the computer software application programs to multiple operating system and database platforms.

Typically it is desirable to be able to customize commercially available computer software in order to modify the program to meet specific end-user requirements; upgrade the program for error corrections or performance enhancements; port the program to a new computer hardware platform; enable the program to operate on a new or different operating system; and/or to enable the program to work with a new or different database. This invention allows applications created using the invention to be customized in many ways including, but not limited to: add, change and delete data items; add, change and delete screens and/or forms; modify application database schemas; modify application messages; modify the application transaction workflow; add logic to existing software transactions; turn on/off selected software features, and even change the names of application data elements.

In general, this invention is based on the concept that all data definitions relative to computer software application programs can be maintained outside the source code in an Application Dictionary and therefore can be changed without modifying the source code. An extensive set of executables and runtime function libraries (Tools Library) manage the data, and include such processes as moving data to and from the screens/forms, validating the data and posting the data to a database.

Although the invention can be written in a wide variety of computer software languages and with a variety of techniques known to those of skill in the art, the present embodiment of this invention is written in C++ using object-oriented techniques.

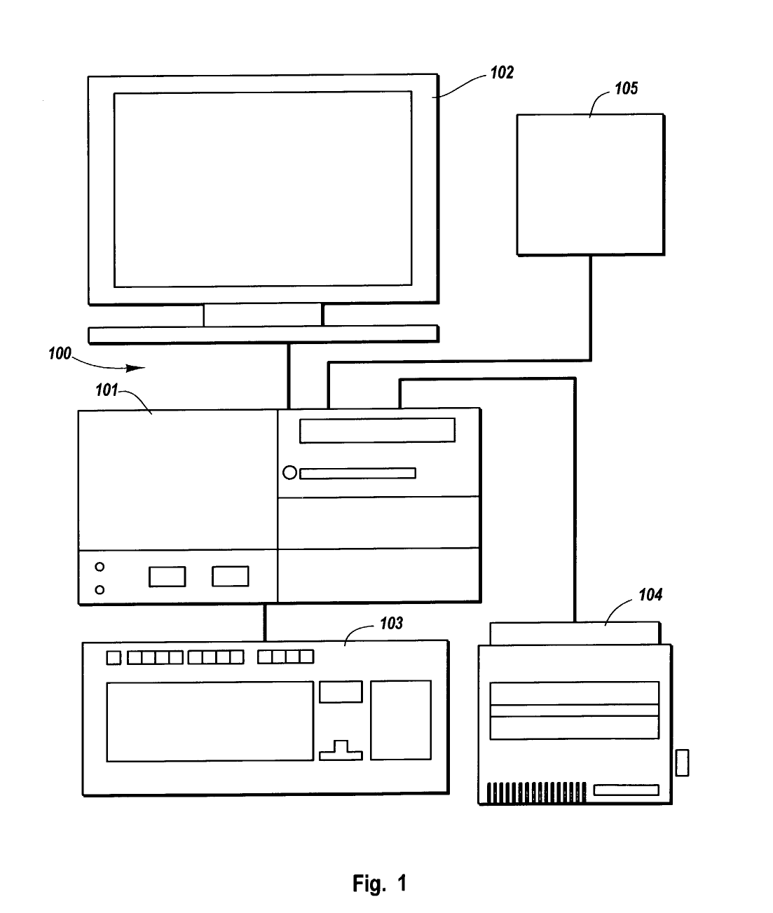

FIG. 1 shows a top-level hardware diagram of the typical computer system implementing this invention. In the present preferred embodiment of this invention a computer system 100 is used to perform the method or process of this invention. This computer system 100 has a processing unit 101, with a processor, memory and a long term storage device, connected to an input device 103, a display device 102, an output printer device 104 and typically a connection to a network device 105, through which the computer system 100 is in communication with additional computer devices. The network device 105 is preferably, although not necessarily, a local area network device. Alternative communication channels, including but not limited to a wide area network, a wireless network, the Internet or the like may be substituted without departing from the concept of this invention. The present computer system 100 is a standard personal computer system, although alternatives such as engineering workstations, mini computers and mainframes can be substituted without departing from the concept of this invention.

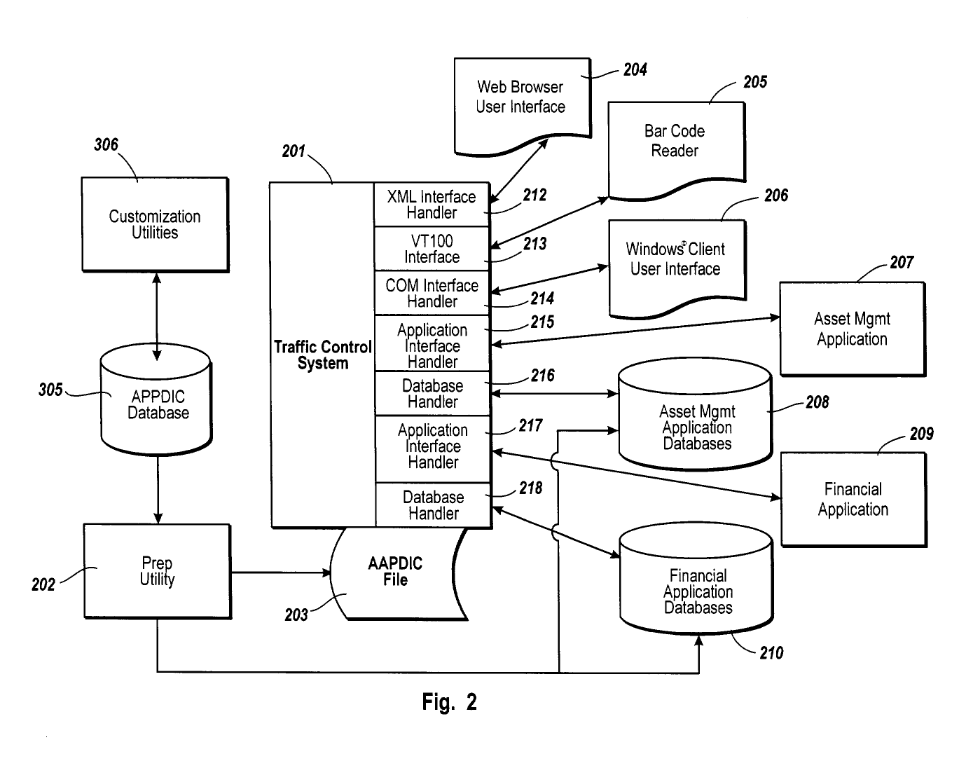

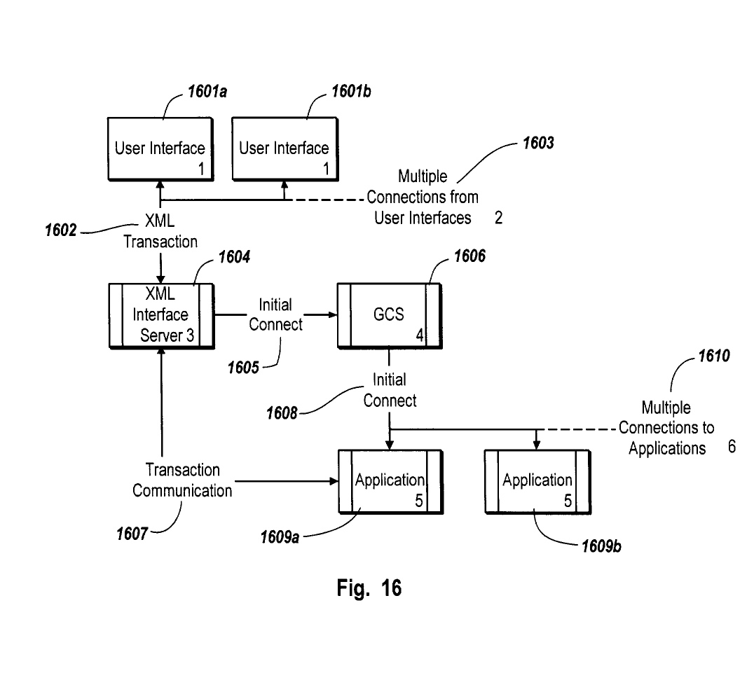

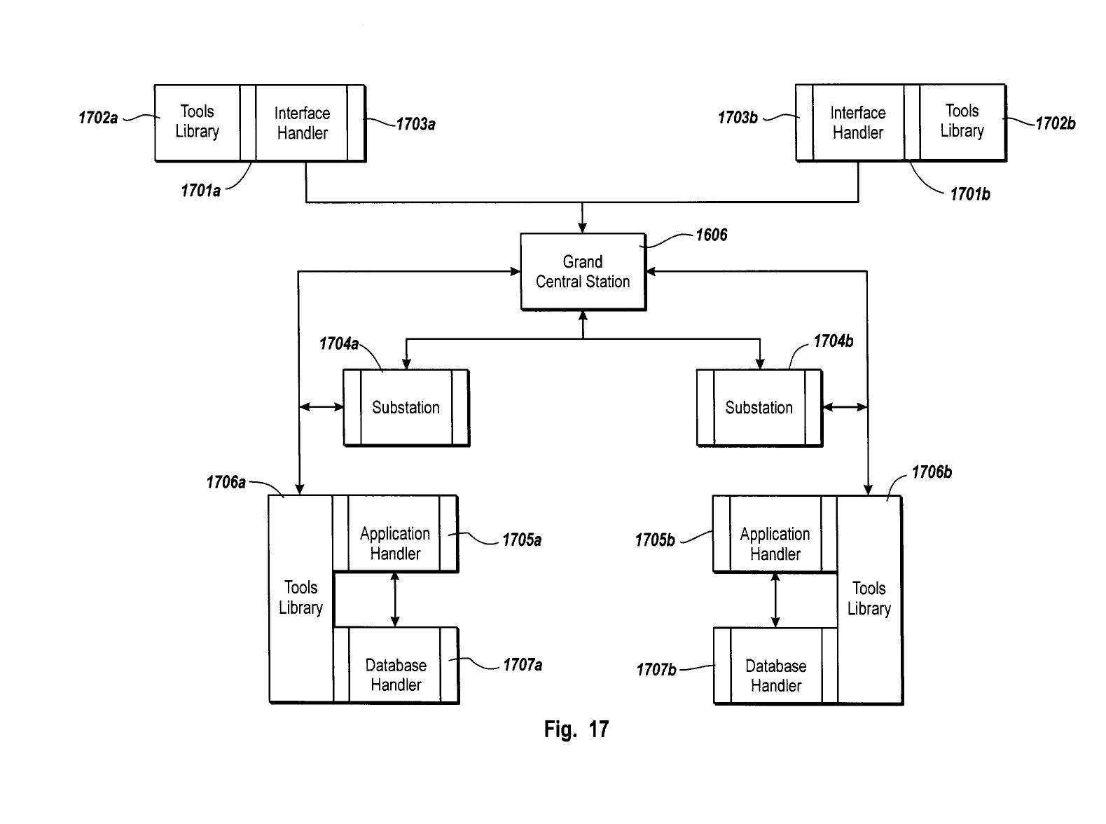

FIG. 2 shows a top level functional block diagram of the present embodiment of the invention. The Traffic Control System 201 is the overall process handling system for the runtime environment. Included within the Traffic Control System 201 are the Grand Central Station, shown in FIG. 16, Substations, shown in FIG. 17, Interface Handlers 212, 213, 214, Application Handlers 215, 217 and Database Handlers 216, 218. Although alternative embodiments of this invention may be fixed in components and scale, the present preferred embodiment is scalable, so that a full system may include one or many Substations, Interface Handlers 212, 213, 214, Application Handlers 215, 217 and Database Handlers 216, 218, in order to handle potentially unlimited client application connections as well as having different components installed and executing on different computers, computer architectures and platforms. The Prep Program or Utility 202 reads the Application Dictionary 305 and builds the runtime environment to be utilized by an application program. This Prep Program 202 also makes any necessary changes to the application databases 208, 210, as defined in the Application Dictionary 305. This Prep Program 202 should be run, or executed, after the information in the Application Dictionary 305 has been changed, so that those changes are available to the end-user when executing the application program. The Application Handlers 215, 217 permit the application programs to access the Function Libraries needed to execute a customizable application program. These Function Library functions include such functions as port communications, messaging, APPDIC interfacing through the APPDIC file 203 generated by prep, buffer manipulation, user exit triggering, tracing and Database interfacing. Interface Handlers 212, 213, 214 are used to provide the process for requesting a transaction from an application program, shown here as an asset management application 207 or a financial application 209. These Interface Handlers 212, 213, 214 may be an interface server (a web, a terminal, or a graphical user interface (GUI) 204), a user interface (a terminal 205 or a GUI 206), an Application Program Interface (API), a Report Writer, an application-to-application interface, or any other process that can make appropriate requests through the Grand Central Station (GCS).

In the present embodiment of the invention, the Interface Handlers 212, 213, 214 first request an application connection by contacting the GCS with information such as the application program to be accessed, security information and an open listening socket port on the Interface. The GCS passes on the information through a Substation 1704a,b, which contacts the Interface on the specified port. The connection to the GCS is typically not maintained, although the Interface Handler 212, 213, 214 may maintain their connections. After the initial connection is completed, the Interface Handler 212, 213, 214 may request application transactions via the connection. These requests preferably, but not necessarily, contain information such as application name, security information, transaction name, and transaction data. Closing the connection is typically the responsibility of the Interface Handler 212, 213, 214. The order of these steps is only that of the present preferred embodiment. It is envisioned by the inventors that alternative steps and ordering of steps is possible, foreseeable and would be equivalent based on the teachings of this disclosure.

Database Handlers 216, 218 are generally specific to the particular database platform (i.e., Oracle, DB2, etc.) to be accessed through a dynamic library for that particular platform. Database connections are typically opened by a function that queries an Application Handler 215, 217 for its associated application databases 208, 210 and types. Each Database Handler 216, 218 manages the connection and interface to the database platform 208, 210 it is designed to access. Although not necessarily required in every embodiment, in the present embodiment of the invention the following interface functions are provided: connect, disconnect, refresh connection, create transaction, create database (optional), open database exclusively (optional), get connected user information (optional), set transaction isolation level, begin transaction, commit transaction, rollback transaction, create statement, execute statement, release statement, move to next statement record, and test for end of statement record set. The Database Handler 216, 218 also manages transactions requested by the application program, 207, 209. The presently provided database functions include: end a transaction by committing or rolling back; execute an SQL statement (typically based on buffer and database keys); execute a dynamically defined SQL statement; dynamically define a Select statement (based on one or more buffers); dynamically define an Insert statement (based on a buffer); dynamically define an Update statement (based on a buffer); dynamically define a Delete statement (based on a buffer); dynamically add a Where clause (based on one or more buffers and database keys); and dynamically add an Order By clause (based on one or more buffers and database keys). Additional database functions are possible and envisioned as likely by the inventors.

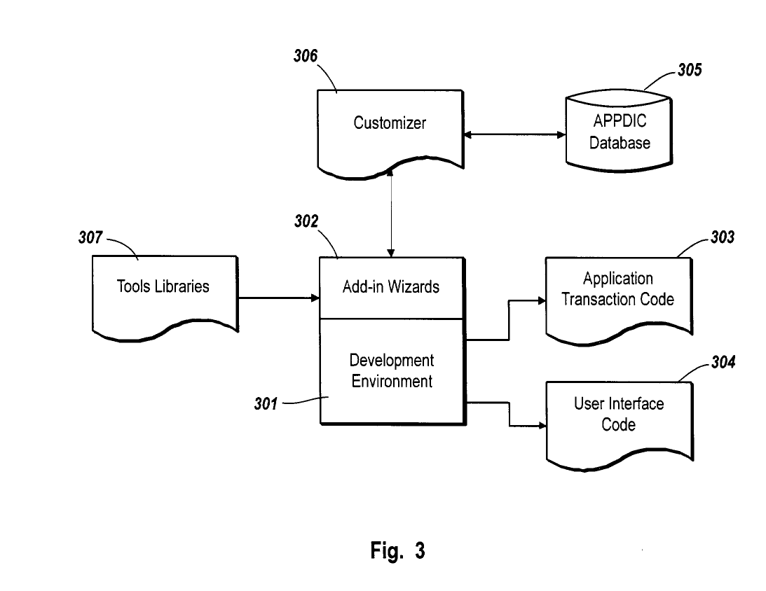

FIG. 3 shows a top level functional block diagram of the preferred application development environment of the present embodiment of the invention, which for example could be configured to work with off-the-shelf application development environments 301. MS Visual Studio is a product of Microsoft Corporation and represents an example of an application development environment 301. This invention is not limited to use with MS Visual Studio or any other application development environment. For the purposes of this disclosure a “Wizard” is a computer program element that, once initiated operates to modify the functionality of an existing program with minimal user interaction. As noted above, the program environment of this invention is a set of programs and functions that permits a developer to design and program applications that can be customized. When used Add-in Wizards 302 are installed in or to the pre-existing application program 301, in this example MS Visual Studio. Application Transaction Code 303 is created and managed using the pre-existing application development environment 301. User Interface Code 304 is also created and managed using the pre-existing application development environment 301 for use with the application transaction code 303. An Application Dictionary (APPDIC) Database 305 is a complex database that contains the definitions of data elements, buffers, literals, messages, tables, data structures, and all other information pertinent to the operation of an application. Once information is defined to the Application Dictionary Database 305, it does not have to be defined within the application transaction code 303 and can be accessed by its own unique identifier using the function libraries of this invention. Customization Utilities (or Customizer) 306 interface between the APPDIC Database 305 and the Add-in Wizards 302. The Customization Utilities 306 include a set of transactions that allow additions and/or modifications of the information stored in the Application Dictionary Database 305. In the present embodiment of this invention, these Customization Utilities 306 can be operated in two different modes: Normal mode and Designer mode. Designer mode is typically used by an application developer to define the application and its data components in the Application Dictionary 305. Normal mode is typically used by an end-user to modify the predefined applications definitions and thereby to customize the application for a specific purpose. Function Code Libraries 307 are provided to accommodate and facilitate the ability of a programmer to write application transaction code 303 that do not contain definitions for the data to be manipulated and for the program to receive those definitions at runtime and to still be able to operate properly even after the definitions have changed. Other components of this invention's program environment, shown in FIG. 2, include: a Prep Program 202, a Traffic Control System (TCS) 201, a Grand Central Station (GCS), one or more Substations, Application Handlers 215, 217, Database Handlers 216, 218, and Interface Handlers 212, 213, 214. Each of which is discussed in additional detail either previously or below. Although the application transaction code 303 can be written in a wide variety of computer software languages and with a variety of techniques known to those of skill in the art, the present preferred language for writing application transaction code 303 is C++ using object-oriented techniques.

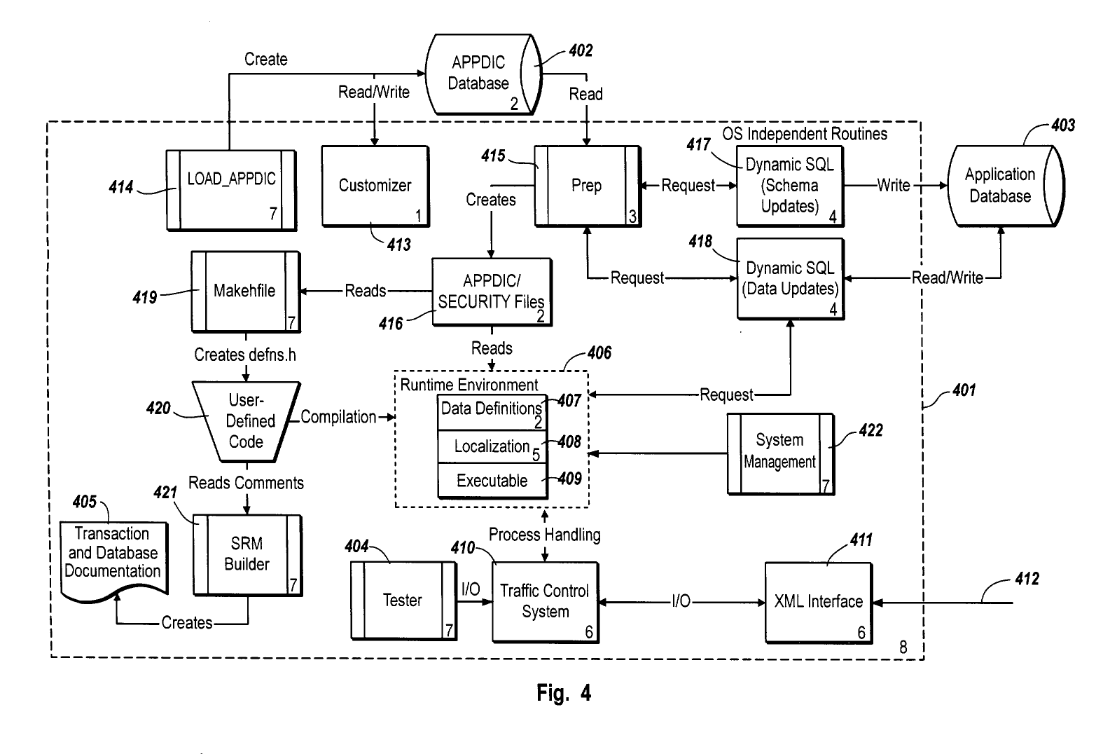

FIG. 4 shows a top level block diagram of the preferred system of this invention. The invention includes both Operating System (OS) Independent Routines 401 and peripheral modules. The peripheral modules include the APPDIC Database 402, and the Application Database 403. A Tester Utility 404 and Transaction and Database Documentation 405 are also provided as shown. The following is a description of the utilities, functions and routines that make up the OS Independent Routines 401 and the peripheral modules 402, 403, 404, 405 and are referenced to the components of this FIG. 4 in which they relate. A library of utilities are provided to permit an application to be customized, by the customizer 413, at many levels without changing the original source code. This is accomplished by maintaining the data definitions external to the original source code in an application dictionary, which typically is stored in the APPDIC database 402. The customization functions (also known as the customizer) 413 provide access to the application dictionary 402. The method of customization 413 of this invention serves to simplify and enhance the software upgrade and support process. Customizer 413 is the utility for editing the application dictionary. The present embodiment of Customizer 413 has two distinct modes: one for application designers and one for post-implementation user. Customizer 413 contains the logic necessary to maintain and update the application dictionary 402. The application designer's mode of the Customizer 413 allows the designer to make changes to all the data maintained in the application dictionary 402 necessary to the application. Data maintained in the application dictionary 402 includes but is not limited to: application definition, format definitions, field definitions, data structures, system values, literals, application database definitions, application messages, user exits, transaction definitions, and application security. In the present post-implementation mode, changes the end user can make include but is not limited to: (1) modify the database schemas; (2) alter field and format definitions; (3) alter data structure definitions; (4) write user exits to alter transaction workflow; and (5) turn on/off software features using system values.

Data-definitions are maintained primarily in the Application Dictionary 402, the APPDIC/Security Files 416, and are stored in the data definitions section 407 of the Runtime Environment 406. The data-definitions of the APPDIC/Security Files 416 are created by the Prep Process 415 and are created from the information contained in the Application Dictionary 402. The Application Dictionary 402 is a database containing information about the applications it supports and their associated fields, buffers, databases and transactions. APPDIC and Security Files 416 are accessed during Runtime and provide the required data definitions to the executables of the applications. The following describes the present embodiment of the different elements whose definitions are maintained in the Application Dictionary 402 and APPDIC and Security Files 416. Fields are defined as the base data element. Each field has a name and properties that define its type, size, etc. Presently, this information is stored in the Field_Descriptor and Data_Structure tables in the Application Dictionary 402.

In the present embodiment of this invention, the fields exist as objects, which include methods for manipulating the field data. Types of actions permitted by the these objects include, but are not necessarily limited to: (1) arithmetic operations; (2) comparison operations; (3) data movement operations (in/out of buffer); (4) data validation operations; and (5) data conversion operations. In the present embodiment of the invention, each field is classified as particular datatype, for example: STRING is any character, left justified; D_INTEGER is a 32 bit integer; DATE_MDY_DISPLAY is MM/DD/YY; and TIME_{—}12HR_DISPLAY is HH:MMA. Additional and alternative datatypes are anticipated and the use of which within this invention, should be considered within the scope of this invention.

One of the important aspects of the functions provided in the Tools Library of this invention is Buffer Manipulation. This invention uses buffers (logical groupings of data elements or fields) to move data in and out of an application transaction. These functions include functions which can create buffers and fields based on a definition stored in the Application Dictionary 305 format or based dynamically on a list of field numbers. Through the use of other functions, application programs can perform arithmetic operations on buffers and fields, and can perform data conversions on fields within a buffer. Other functions clear buffers or move field data between buffers. Still other functions are provided to get data types, lengths, decimal places, field numbers, names and other flags associated with individual fields. Validation and data comparison functions are also provided for fields. Buffers are collections of fields. Each buffer has a type. Presently, valid buffer types include: screen, database, and intermediate, although alternative and additional buffer types can be employed within the scope of this invention. Buffer information is currently stored in the Format_Descriptor and Data_Structure tables in the application dictionary. Types of actions presently permitted on buffers include: (1) arithmetic/comparison operations between fields or buffers; and (2) data movement operations (between buffers). This invention provides a function that performs a corresponding movement of data between two buffers. In this function, data from all fields that exist in both buffers are transferred. It is this function that is used to permit transactions to transfer information that they know nothing about, allowing users to add any data they wish to the transaction buffers, and for the transaction to transfer the information along.

Database definitions contain a list of buffers that are contained in a particular database. This invention permits database relationships to be defined, including primary keys, unique keys, constraints, and foreign keys. The present embodiment of the invention supports the following database drivers: (1) Interbase 6.0; (2) Oracle 8.0; (3) IBM DB2 7.1 and (4) MS SQL Server 7.0, although it is envisioned that additional database drivers will be added without departing from the concept of this invention. Each database driver contains a descriptor record that describes some of attributes of the database, such as (1) maximum data type sizes; and (2) support of two phase commits. The following actions are presently supported on databases: (1) Open/Close/Create(on some but not all database drivers)/Refresh database connection; (2) transactional handling; and (3) statement execution and navigation of result set data.

Transaction definitions consist of defining the available transactions, user exits and the associated buffers. System values are a set of system wide parameters that are defined by the application designer and are used to control the manner in which the application functions or which provide static data definitions to the application transactions. Literals are data elements that have a predefined set of values. Entry of these data elements by an application user is validated against this set of values to check entry accuracy. Security information defines application users and establishes what access these users have to an application and its associated transactions and data.

Prep 415 is a process that can be executed by both application designers and post-implementation user to allow modification to the application program without affecting current users. In the present embodiment of this invention, the prep process is executed before changes to the Application Dictionary 402 becomes effective. Essentially, although not exclusively, the prep process performs the following major functions: (1) compile and index the Application Dictionary 402 into a form that is used by the runtime libraries 307 of this invention (this includes data, security and localization); and (2) manage changes to database structures. If a change is required to a database structure, the Prep Process 415 makes the necessary modifications to the database to make it match the new structure. The Prep Process 415 compiles application data-definition information and moves the compiled information to the APPDIC File 416.

In the present preferred embodiment, the APPDIC File 416 is created as follows: (1) read all format definition records and add to file; (2) read all field definition records and add to file; (3) read all data structure definition records and add to file, and track total field count in format records; (4) loop through format records, creating an index of fields for the format, including (a) for each control, compute its allocation size and offset; (b) create a default buffer record in the file and fill it using data from the field definition record; and (c) update the format information for size and layout.

In the present preferred embodiment, database records for APPDIC Database are created as follows: (1) read all database definition records and add to file; (2) read all dataset definition records and create links to appropriate database and format and add to file; and (3) read all database relationship records and create link to field definition, create link to dataset definition, create link to target format if possible, and create link to target field if possible.

In the present preferred embodiment, system value/literal records are created by (1) read count of all System Value records; (2) allocate room for data structures, field records; (3) read all System Value records; (4) create fake field record, using system value name for field name and using system value for default field value; (5) create fake data structure record, linking field to “SystemValue” format; (6) repeat steps 1-5 for Literal definition records; (7) read all Literal Group definitions and add them to the file; and (8) read all Literal Relation definitions, and create links between the Literal group and literal definition and add literal group record.

Security information for all applications is contained in the application dictionary database. The present process for creating a Security File 416 is as follows: (1) create user records by reading Security User records and adding to the Security File; (2) create screen records by reading Security Screen records and adding to the Security File; (3) create field records by reading all Security Field records and adding to the Security File; (4) create group records by reading all Security Group records and adding to the Security File; and (5) create header and indexes, by looping through all Security User records, creating all offsets for Security Screen records associated with the current user id, creating all offsets for Security Field records associated with the current id, and creating all offsets for Security Group records associated with the current user id.

Once the compilation stage is completed, the Prep Process 415 loads both the old and the new application definitions into memory and looks for differences between the two definitions. It is during this stage of the Prep Process 415 that changes in constraints, primary keys, tables and fields are identified. The general sub-process of this section of the Prep Process 415 is as follows: for each database table, (1) check if the table has just been created or deleted, if so, then mark the table and constraints for creation or deletion and then go to the next table; (2) check that the table has not changed databases, if so, then mark the table for update and then to the next table; (3) for each field in the table, first check that each field has the same type and length, if not, then mark the table for update and go to the next table and then check for fields that have been created or deleted, if some have, then mark the appropriate field for creation or deletion. And (4) check the table constraints for changes. If a field length or type within a table changes, the table is marked for ‘update.’ The update process occurs during the comparison process, but maintains a record in the list of updates so that in the case of a rollback, the new table will be deleted. The update process includes: (1) creating a new table; (2) moving and/or converting the data to the new table; and (3) dropping the old table.

The present database update process goes through the list of required changes and implements the changes in the following steps: (1) drop foreign keys; (2) drop other constraints; (3) perform table/field updates, by (a) determining if a table ‘update’ was found and (b) performing table/field updates; (4) add other constraints; and (5) add foreign keys. If an error occurs during this process, the database(s) are rolled back to a previous state. If a table was updated, then the new table is deleted.

Once all of the database and runtime updates have occurred, the Prep Process 415 creates the user exit definition files for the application. The final step of the present Prep Process 415 is to make a backup copy of the old runtime definition files and to move the new files over into the active stage.

Dynamic SQL (schema updates) 417 and (data updates) 418 process the database queries using the appropriate buffer definition. The following SQL commands are currently supported: INSERT; SELECT; UPDATE; AND DELETE. The dynamic SQL 417, 418 generation of the present embodiment automatically generates the correct syntax for each supported data type. The present list of supported data-types for database access is as follows: strings, BLOBs, integer numeric fields, decimal numeric fields, dates and times. The Prep Process 415 uses an extended set of SQL commands. The SQL generator 418 for the Prep process presently supports all of the above commands and also adds the following database administration commands: add/remove table, add/remove field, and add/remove table constraints.

Localization 408 extends the data definition capabilities by allowing certain elements to be defined in multiple languages. The localization 408 process gives all application messages a particular number for referencing in the code. Based on the current users' language settings, the localization 408 process looks up the appropriate error message. Error messages may also contain tags that allow data to be inserted into the resulting string.

Interfaces 411 define the manner in which a process 412 communicates with an application of this invention to request access to an application transaction and how data is moved back and forth between the two. The present embodiment of this invention makes use of an XML interface for the interface 411, although a wide variety of other computer communication interfaces are well known to those of skill in the art and which can be substituted without departing from the concept of this invention.

The traffic control system 410 is responsible for making connections to interfaces and routing traffic between the different components. The components of the traffic control system 410 are either two-way pipes or sockets to communicate, depending on the operating system being used. The traffic control system 410 includes a component called the Grand Central Station (GCS) 1606. The present connection process performed by the traffic control system 410 is as follows: (1) an interface 411 connects to GCS 1606 and requests connection to an application; (2) the GCS 1606 chooses an open application and the application issues a connection attempt back to the interface; (3) the GCS 1606 closes the connection to the interface 411; and (4) the interface and application correspond directly from that point on. Message passing, in general is performed as follows: (1) all messages are provided a message header; (2) the type of message is described; (3) the routing information is included; and (4) the message information is compressed. Transaction messages are processed as follows: (1) each transaction message is assigned a transaction header; (2) the type of transaction message is determined; (3) the transaction ID number is identified; (4) the format number is determined; and (5) the packet order is provided. The present embodiment of this invention employs RLE compression on messages, although many compression techniques are well known and the substitution of an alternative compression techniques is within the scope of this invention. IOCompletion ports presently are used in the Windows operating system in order to optimize performance. Alternative operating systems and functions/routines can be substituted without departing from the concept of this invention.

The system administration interface, also referred to as the System Management 422 component. The System Management 422 allows the users to start and stop an application, configure processes, and review active processes.

The runtime environment 406 includes the data definitions 407, localization routines 408 and executable code 409. A number of utility programs are provided for use by application designers for use in creating a customizable application. These utility programs include: the tester 404, which allows application designers to test their transactions; the System Reference Manual (SRM) builder 421, which searches the source code for tags and creates HTML documentation 405; the Makehfile utility 419 read the current Prep information and create a file which includes the constants necessary to compile the user code 420; and the Load APPDIC 414 utility creates a base compiled application dictionary consisting, preferably, of the minimum references to run the Prep Process 415.

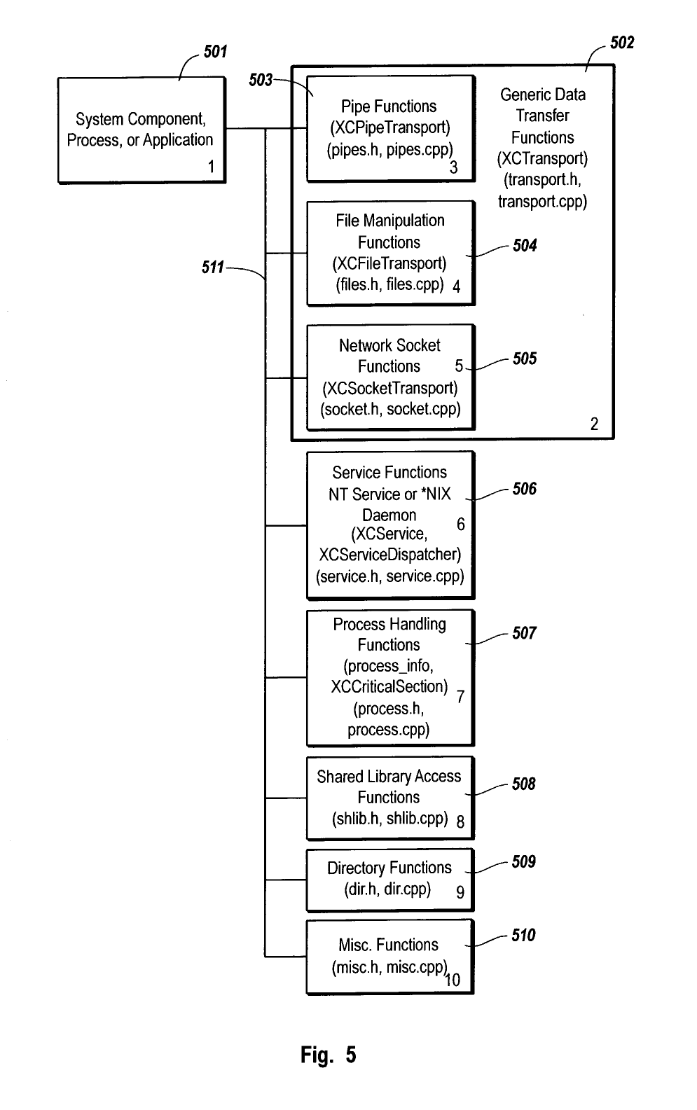

FIG. 5 shows a diagram showing the available operating system (OS) independent functions of the present embodiment of this invention. The functions shown in this figure are the general operating system independent functions that can be accessed by a system component in the present embodiment of this invention. These functions may be implemented differently depending on the selected operating system. The system component, process or application 501 represents a system component, process or application. The lines 511 between this object 501 and the others 502-510 demonstrates that the system component, process or application can use any of the functions of these other objects 502-510. The generic data transfer functions 502 represents a base class for all generic data transfer functions. The present preferred generic data transfer functions 502 base class is the XCTransport class, contained in the source code files transport.h and transport.cpp. Pipe functions 503 represents a class derived from XCTransport that contains data transfer functions specifically for OS pipes. The derived class in the present embodiment of the invention is XCPipeTransport class, contained in the source code files pipes.h and pipes.cpp. The File Manipulation Functions 504 represents a class derived from XCTransport that contains data transfer functions and manipulation functions adapted specifically for OS functions. The derived class is the XCFileTransport class, contained in the source code files files.h and files.cpp. Network Socket Functions 505 represents a class derived from XCTransport that contains data transfer functions specifically for the OS Network Sockets. The derived class is the XCSocketTransport class, contained in the source code files socket.h and socket.cpp. The Service Functions 506 in the present embodiment represents functions for NT Services and UNIX types (including Linux) Daemons. These functions 506 are implemented through the XCServices and XCServiceDispatcher classes, contained in the source code files service.h and service.cpp. Process Handling Functions 507 represents functions for handling OS processes. These functions 507 are implemented through the process_info and XCCriticalSection classes, contained in the source code files process.h and process.cpp. The Shared Library Access Functions 508 represents a group of functions for accessing OS shared libraries. This function group 508 is contained in the source code files shlib.h and shlib.cpp. The Directory Functions 509 represents a group of functions for accessing OS file directories. This function group 509 is contained in the source code files dir.h and dir.cpp. Misc. Functions 510 represents a group of miscellaneous functions, currently including functions for character string manipulation and comparison. This function group 510 is contained in the source code files misc.h and misc.cpp.

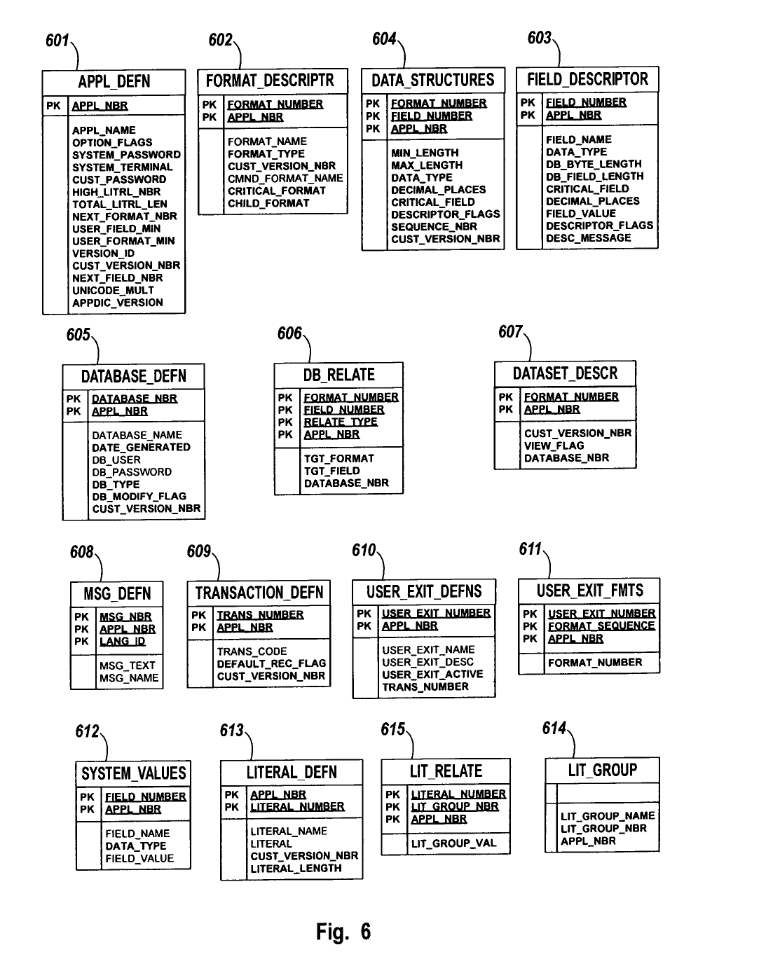

FIG. 6 is an object diagram and documentation of the major portions of the APPDIC database. An APPL_DEFN 601 defines an application and typically includes the application name, and information on an application. The FORMAT_DESCRIPTR 602 defines the formats in the system, each format having a unique number, along with names and types, within an application. FIELD_DESCRIPTOR 603 defines the fields in the system, each field having a unique number, a name, type size and defaults, within a system. DATA_STRUCTURES 604 defines buffers, links formats and fields together and stores information such as type, sizes and sequence within the buffer. DATABASE_DEFN 605 defines database connections in the system, each database having a unique number for an application, as well as a name and login information. DB_RELATE 606 defines primary keys and constraints within a database. DATASET_DESCR 607 defines tables within a database. Typically, a record exists for each format that will be used with a database table. MSG_DEFN 608 defines messages within the system. Each message has a unique number and a language identification within an application. The message typically contains the actual text of the message and a message name that can be referenced in source code. TRANSACTION_DEFN 609 defines the available transactions within the system, each transaction having a unique number, and which defines the transaction name. USER_EXIT_DEFNS 610 defines the user-exits within an application. Each user-exit has a unique number. The user-exits also have a name, description, an active flag, as well as a link to the transaction in which they are used. USER_EXIT_FMTS 611 defines the buffers passed in a particular user exit. Typically, one record exists for each buffer in the user exit. SYSTEM_VALUES 612 defines the system values within the application. Typically, each system value has a unique number, and also have names, data-types and values. LITERAL_DEFN 613 defines the literal values within an application. Typically, each literal value has a unique number, a name and the actual literal value. LIT_GROUP 614 defines the literal groups within the system, (such as “yes” and “no”). Literal groups typically have a name and a number. LIT_RELATE 615 defines the relationships between LIT_GROUP 614 and LITERAL_DEFN 613. Typically, one record exists for each literal within a particular group.

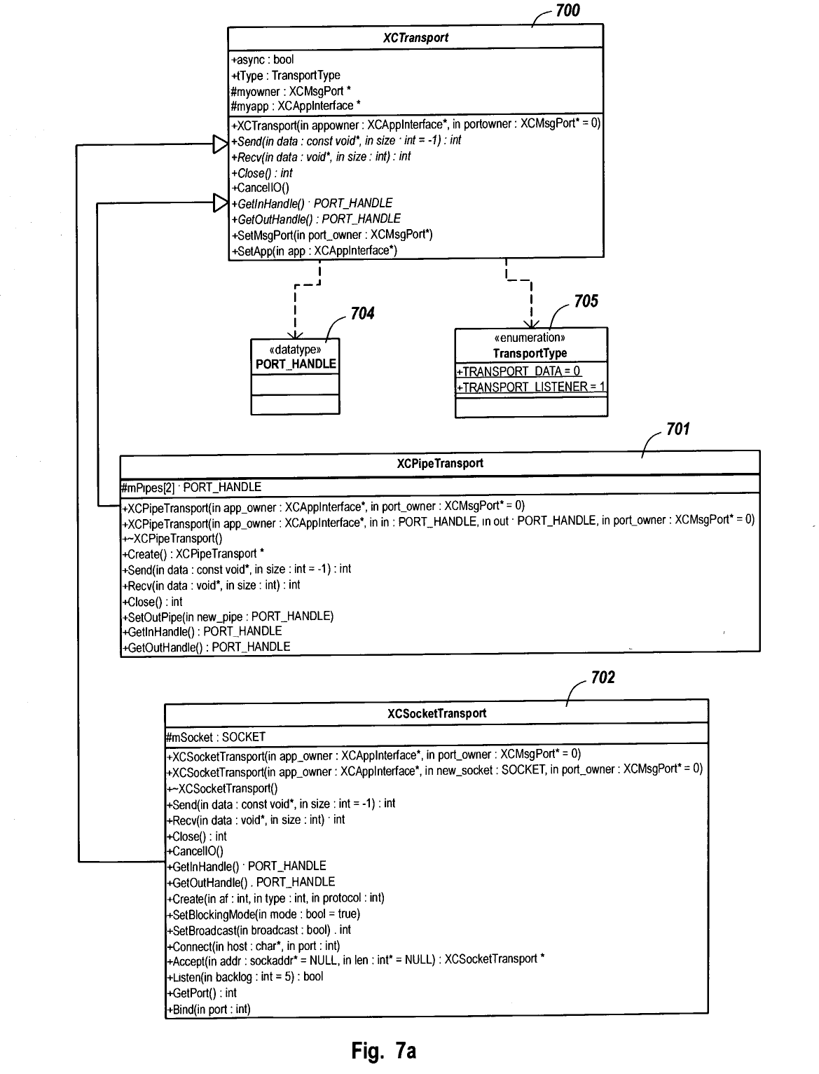

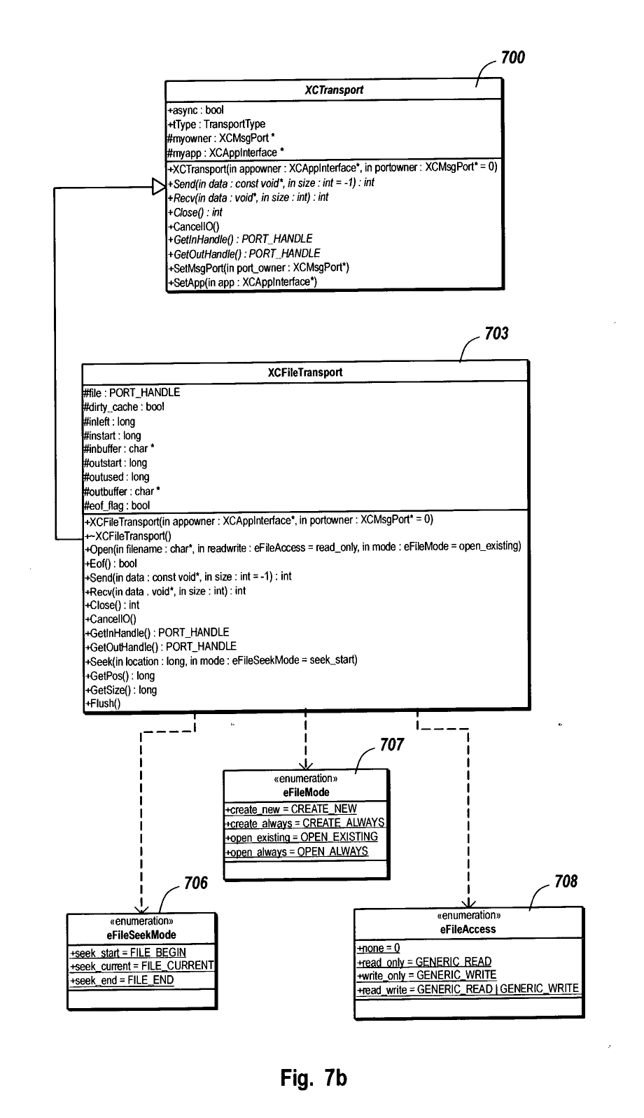

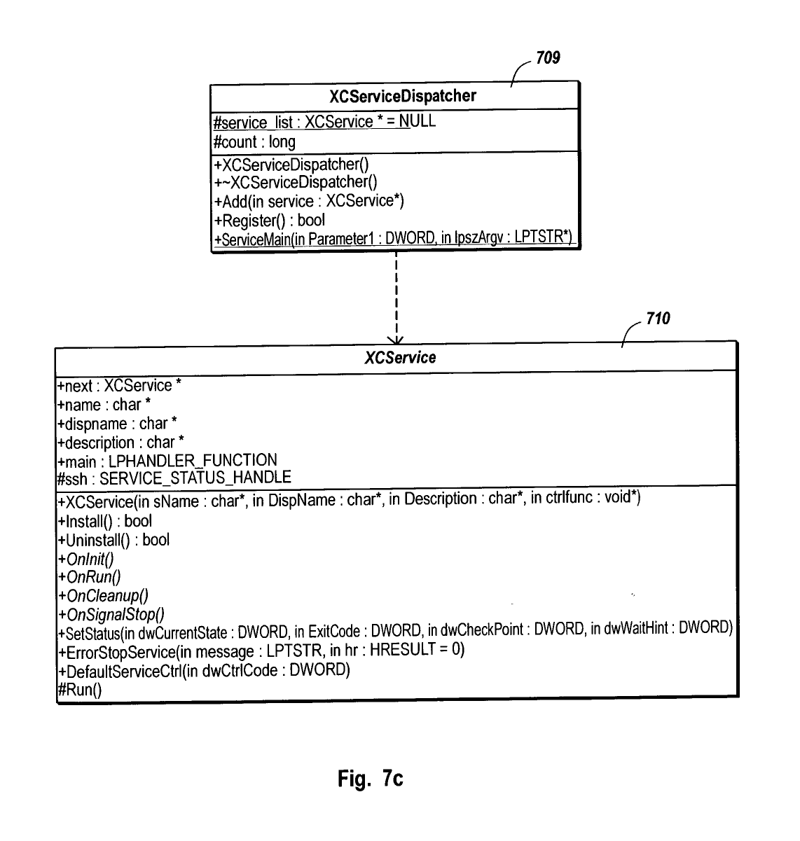

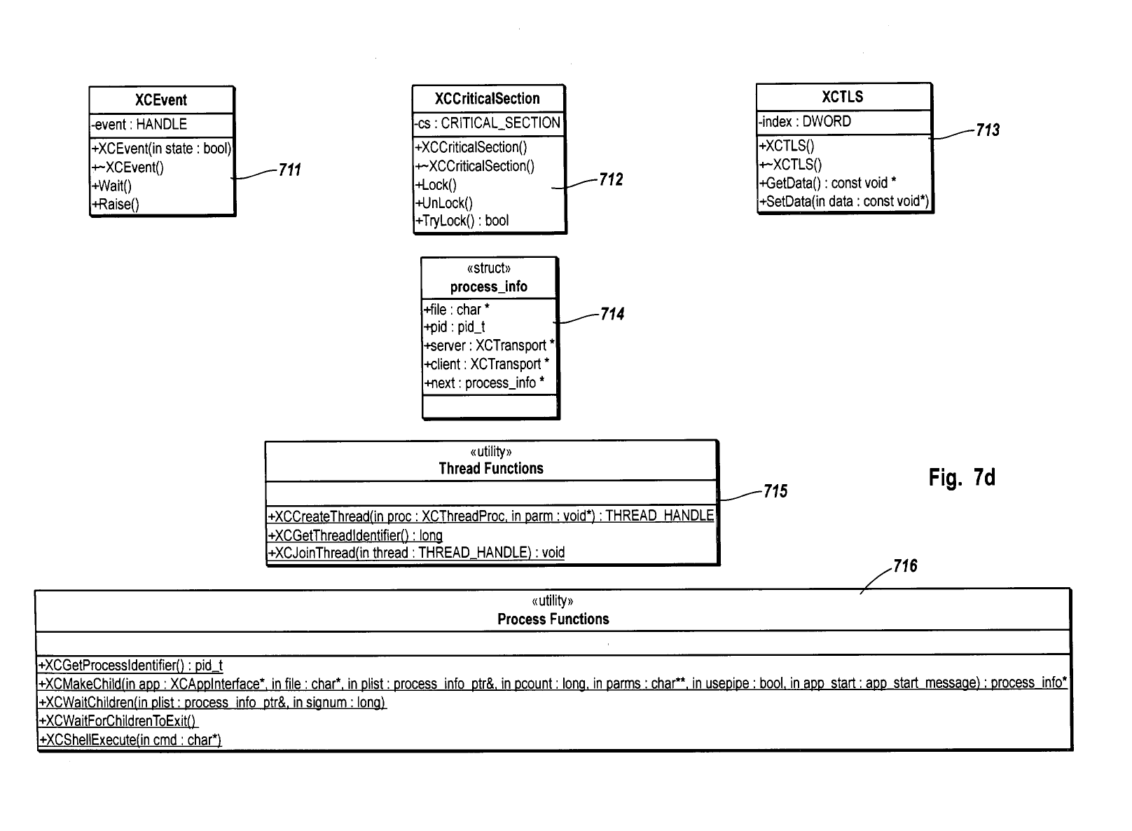

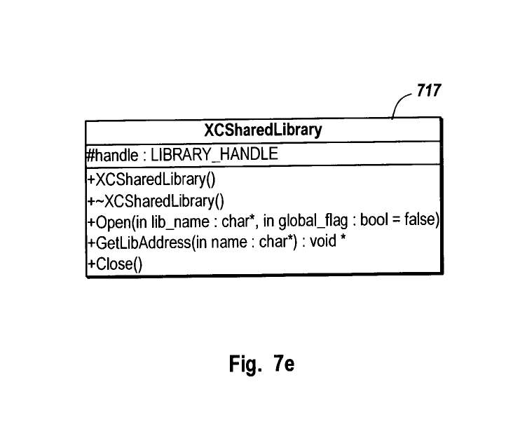

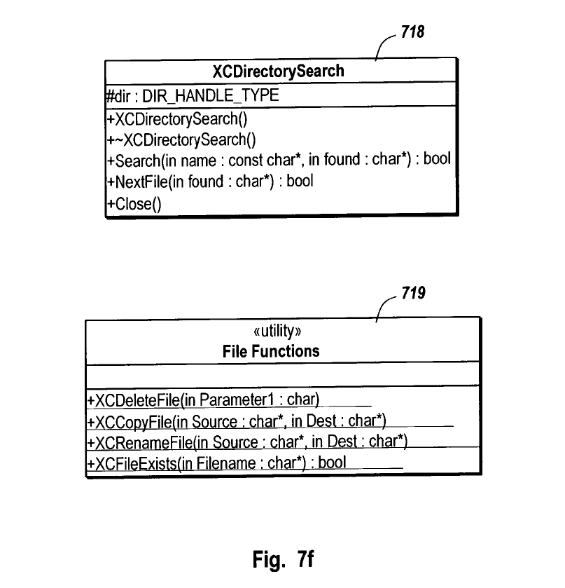

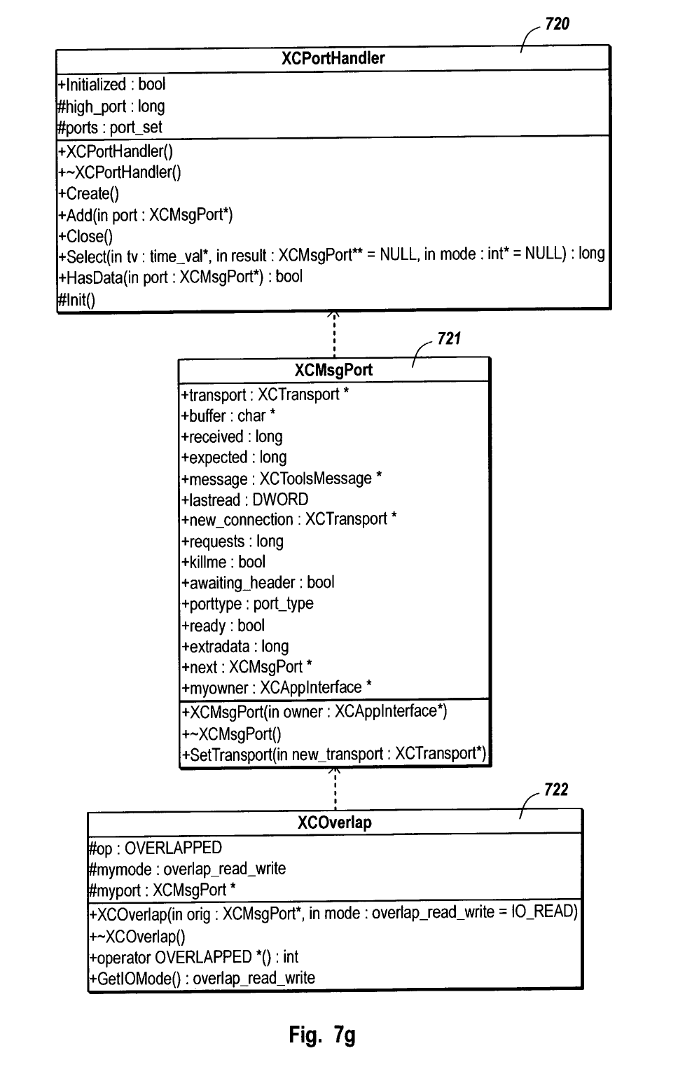

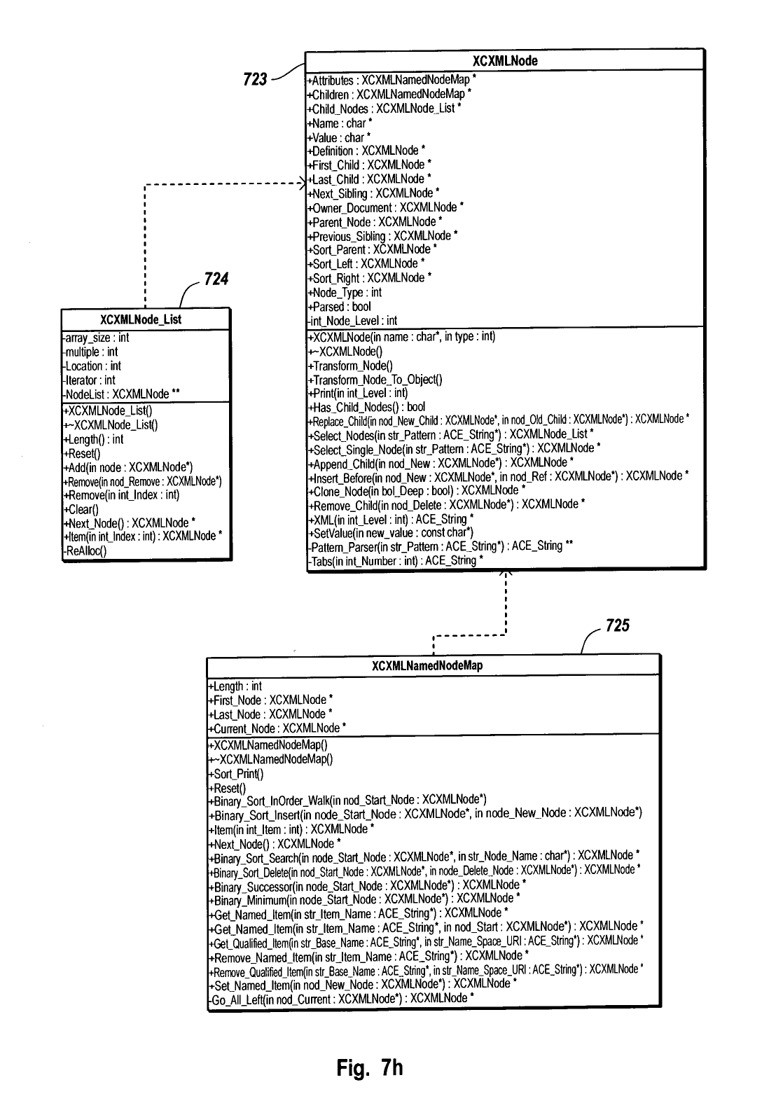

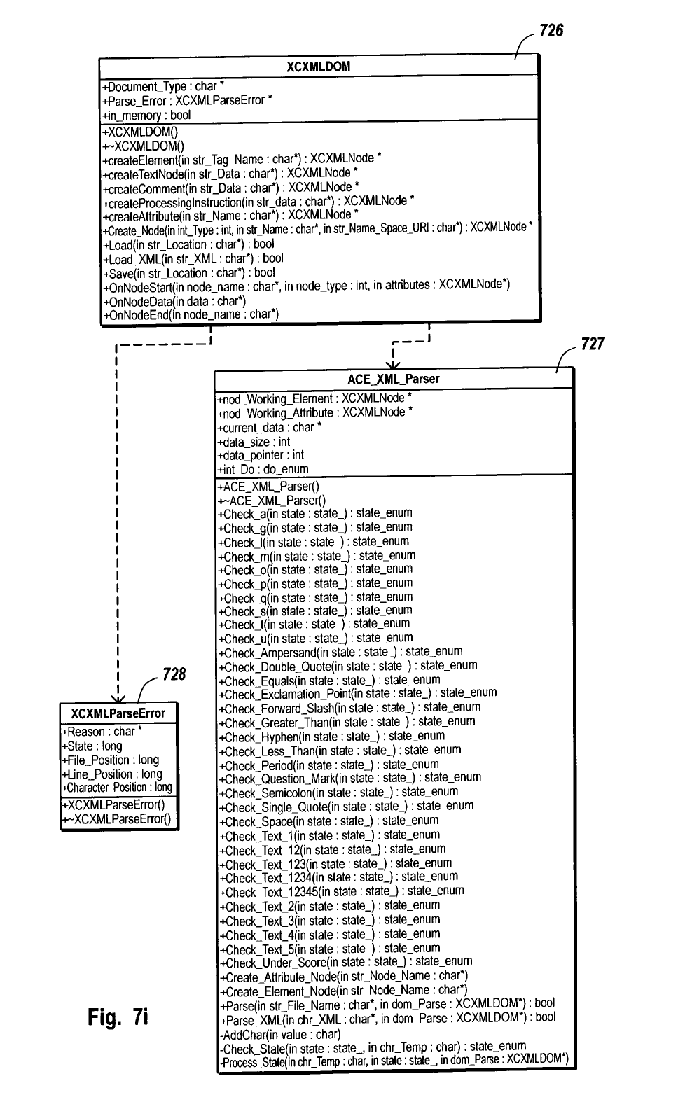

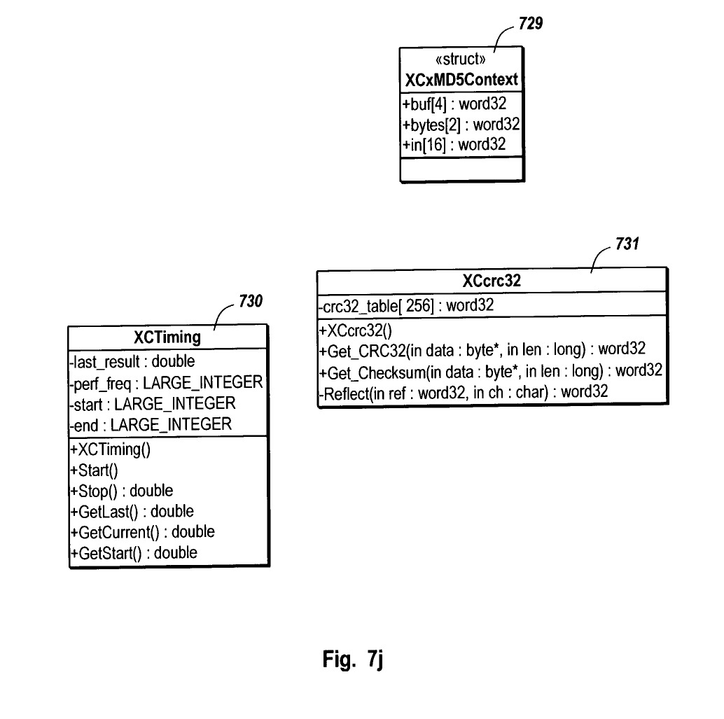

FIGS. 7a-7j are object diagrams and documentation related to the handling of data movement to and from a process, referred to herein in general as General Data Movement Classes. FIG. 7a shows the relationships between the classes XCTransport 700 and XCPipeTransport 701 and XCSocketransport 702, while FIG. 7b shows the relationships between XCTransport 700 and XCFileTransport 703. As shown, each of these classes 701, 702, 703 contains functions for sending and receiving data. These classes 701, 702, 703 also contain additional methods used for each transport type, such as accepting sockets and connections, as shown. The XCTransport classes 700 is shown containing the Port_Handle 704 and the TransportType 705 for use in accepting the sockets and connections. XCPipeTransport 701 uses unnamed pipes to transfer information. XCSocketTransport 702 uses a socket to transfer information and includes functions for listening for and accepting new socket connections; binding to a particular port; setting a broadcast mode, creating a socket and setting the blocking mode of the socket. XCFileTransport 703 uses a file on the host to transfer information and includes functions for the opening of a particular file, which includes setting file access mode (eFileAccess) 708; setting file mode (eFileMode) 707; seeking on a file (eFileSeekMode) 706 and obtaining file size.

FIG. 7c is the object diagram and documentation of the Unix Daemon/Windows Service Routines. The XCServiceDispatcher 709 class contains a list of services requested and adds and/or executes the daemon service. The XCService 710 class is a framework for creating a service.

FIG. 7d shows an object diagram and documentation of the Process Handling Routines. The Process Handling Routines are used to manage processes on a variety of different operating systems. Functions are included for creating processes and threads. The XCEvent 711 class provides thread synchronization, by allowing multiple threads to wait for a specific signal condition. Once that specific condition is signaled, all threads will continue. The XCCriticalSection 712 class provides thread synchronization through the use of a critical section. In this XCCriticalSection 712 class only one process or thread may have the critical section at one time, all other processes or threads are blocked until the critical section is released. The XCTLS 713 class provides a cross-platform method for handling thread local storage information. The Thread Functions 715 include functions for creating and joining threads and include a thread identifier function. The Process Functions 716 include functions for managing process information 714, including returning the process identifier and creating a new child process. The XCWait function is included in the Process Functions 716 for Linux support. The Process Functions 716 also includes a function, XCShellExecute, for executing a process through the shell.

FIG. 7e shows an object diagram and description of the Shared Library Class 717. The XCSharedLibrary 717 class allows shared libraries to by dynamically loaded and allows for searching of particular symbols within the library.

FIG. 7f shows an object diagram and description of the File and Directory Handling classes of the present embodiment of this invention. The XCDirectorySearch 718 class is used to search and examine the contents of a directory. The File Functions 719 includes functions to delete, copy, and/or rename a file and for testing to see if a file exists.

FIG. 7g shows an object diagram and documentation of the present Message Ports of this invention. The XCPortHandler 720 class provides a method for handling multiple XCTransport 700 connections and for determining if the transport is ready to be written to or read from. In the Unix environment a simple select call is presently used. In the Windows environment, IO Completion ports are used. The XCMsgPort 721 class interfaces with the XCPortHandler 720 and XCTransport 700 classes and stores statistical information on a particular transport, such as the number of bytes expected to be read and the number of bytes actually received. The XCOverlap 722 class is used when operating under a Windows operating system (IO completion ports). The XCOverlap 722 class associates a XCMsgPort 721 class with a particular read/write operation and allows the system to use callbacks when the operation is complete.

FIGS. 7h and 7i show the XML Classes in the present embodiment of the invention. XCXMLNode 723 class is the base class for the XML and contains what is necessary for an XML node, including, in this embodiment, the value, name, and parent/child relationships and includes functions for searching of particular XML notes. The XCXMLNamedNodeMap 725 class is an indexed collection of XCXMLNode objects and is used to store and index attribute values for an XCXMLNode 723. XCXMLNode_List 724 is a collection of XCXMLNode 723 objects. XCXMLDOM 726 is the top level node of an XML document. XCXMLDOM 726 contains functions for loading, saving and parsing of XML data. If the in_memory flag is true, the entire resulting tree will be stored in memory. Otherwise, the callback functions OnNodeStart, OnNodeData and OnNodeEnd will be called as appropriate. ACE_XML_Parser 727 class is used internally for the parsing of XML data by the XCXMLDOM 727 class. XCXMLParserError 728 contains information on errors encountered during the parsing of an XML file, which are defined in XCXMLDOM 726 class.

FIGS. 7j shows the Miscellaneous Classes, of compression, encryption, CRC and performance timing. The XCxMDSContext 729 does MD5 hashing. The XCTiming 730 class provides high resolution timers for profiling of an application. The Xcerc32 731 class provides Cyclic Redundancy Check capability, which is used to verify the integrity of the compiled application dictionary.

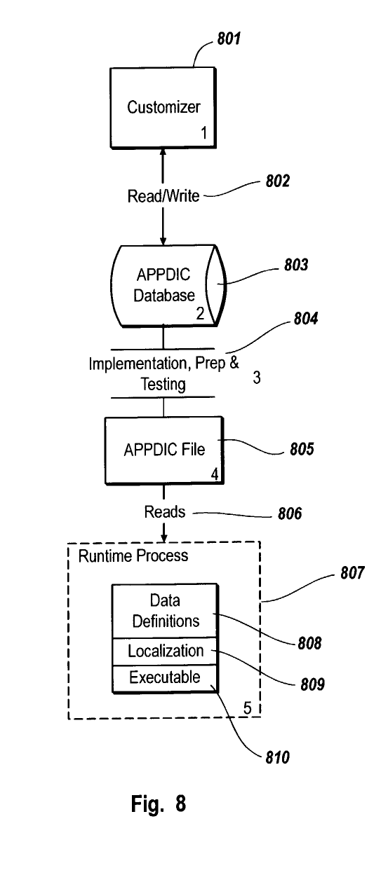

FIG. 8 shows a diagram showing the actions and results of the customization process 413. The customizer process 801 changes application program definitions. This customizer process 801 is made up of transactions that both read and write 802 to the APPDIC database 803 (also indicated as 402 in FIG. 4) to receive and update the application definitions stored therein. The APPDIC database 803 contains the current application program definitions, including field, buffer, table and transaction definitions. Implementation, preparation and testing 804 indicates the actions of the customizer 413 user (either application developer or post-implementation administrator) of using the customizer 413 to implement a new customization, using the Prep Process 415 to create the APPDIC file 805 and testing the implementation through use of the runtime process 807. The APPDIC file 805 is the APPDIC Runtime File that is created by the Prep Process 415, this file 805 contains information relating to the application objects that can be customized. This file is read by the Runtime Process 807 to determine actions on the interface, transaction and database levels. The runtime process 807 is the runtime process of the customizable application, where the process reads 806 the APPDIC file 805 for information of data definitions 808 and localization 809. The runtime process 807 itself is an executable file 810.

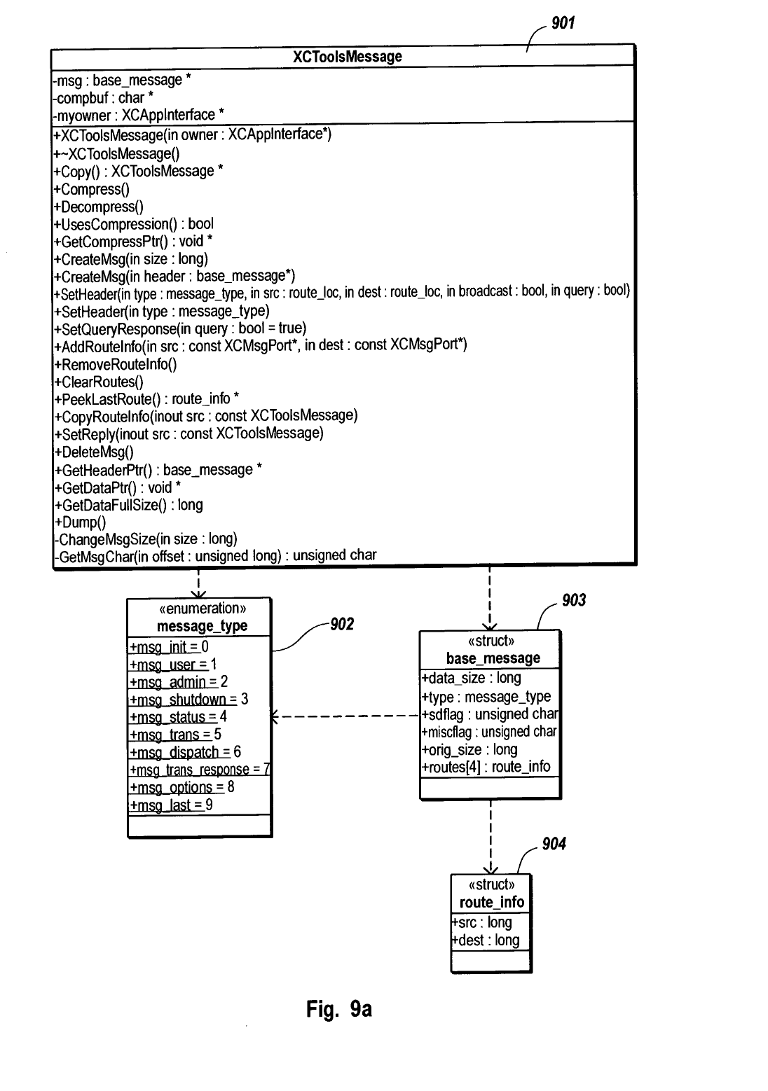

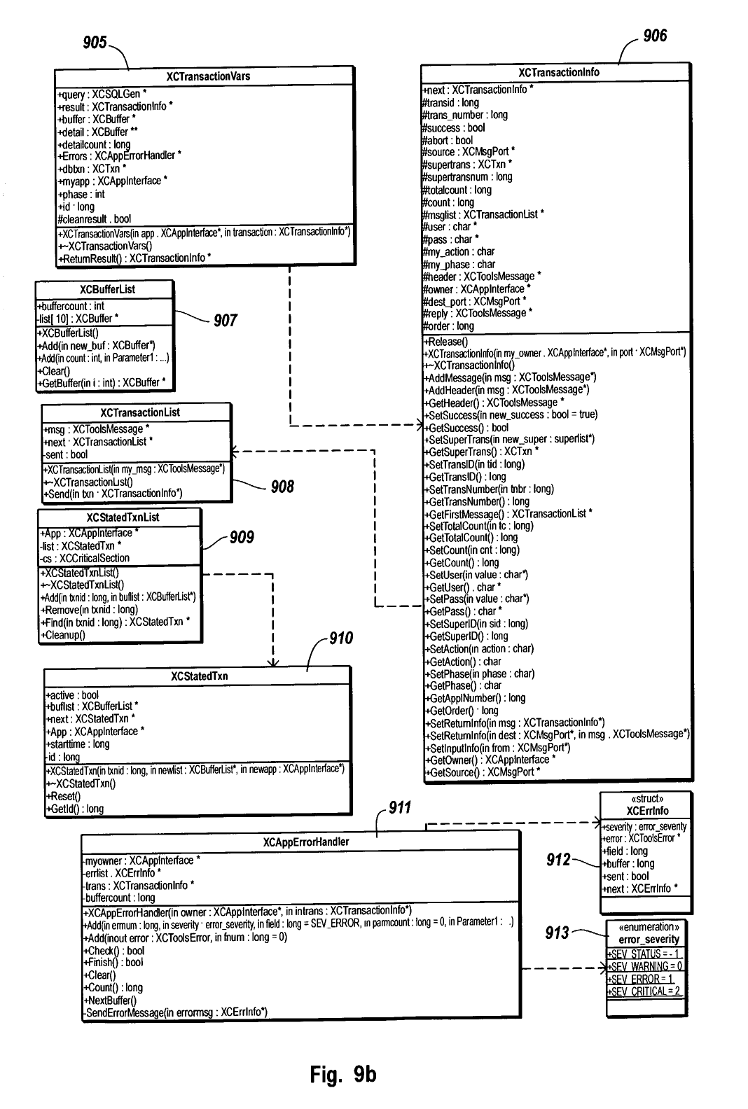

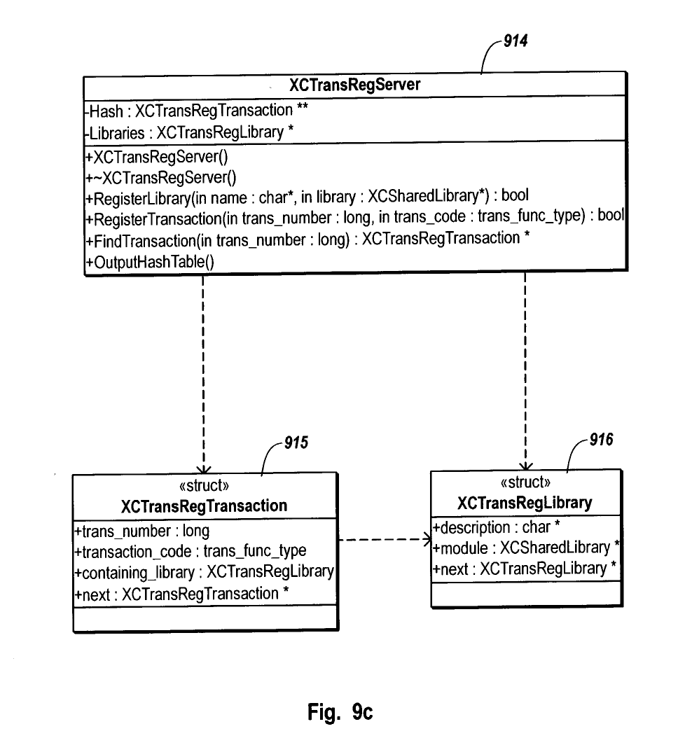

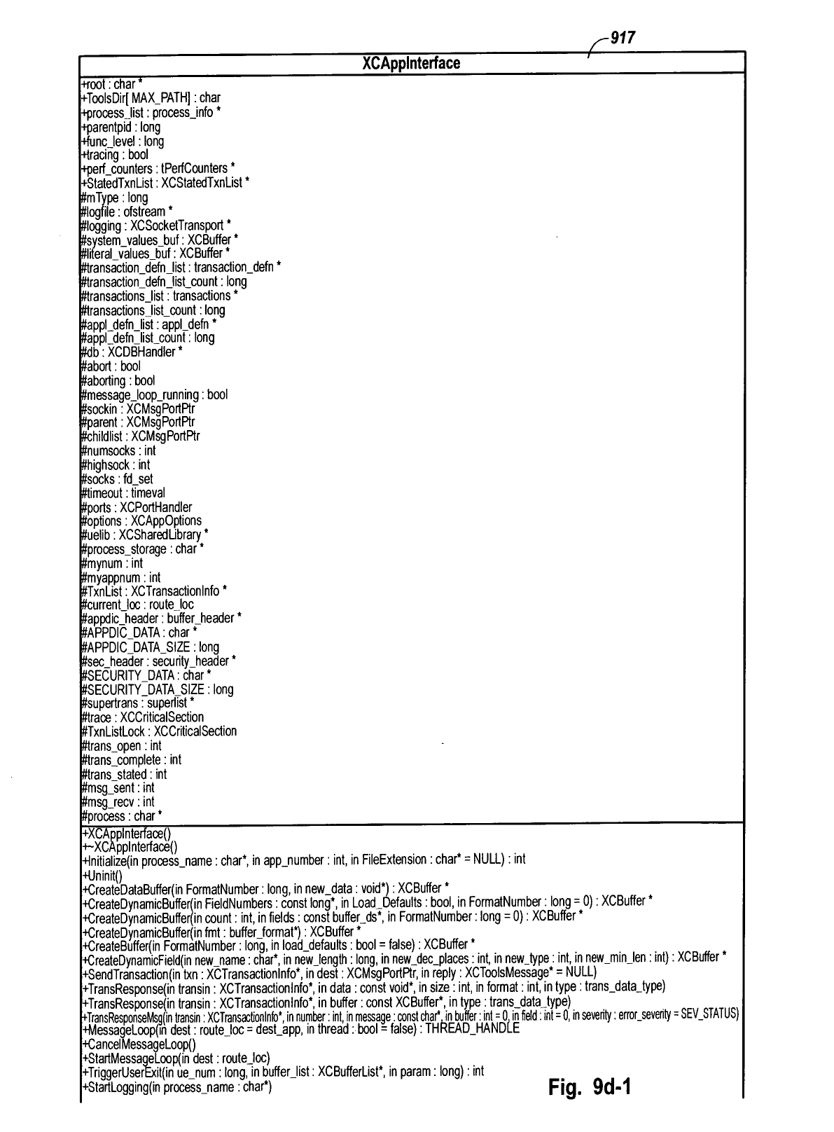

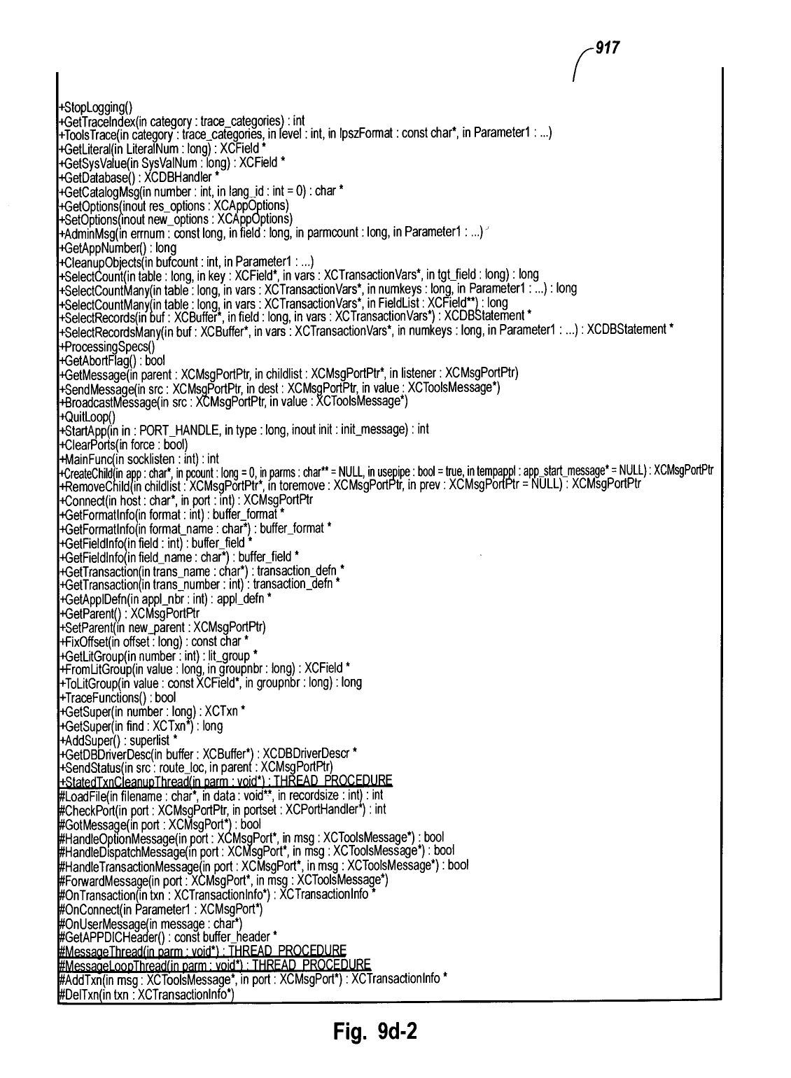

FIGS. 9a-9d depict object diagrams and documentation of the Messaging Routines of the present embodiment of the invention. XCToolsMessages 901 provides a class for managing the routing of messages through the traffic system and allows for compression of data to reduce data transfer size. The base_message structure 903 contains basic information, such as the size of the message, the type of the message (message_type) 902 and routing information (route_info) 904. The message_type enumeration 902 lists the various types of messages utilized by the system. The route_info structure 904 includes the source and destination transport handles for the message, which are used to route messages through the system. Each time a message is forwarded by a process, a route_info value is appended to the list so that the message can return down the same pathway.

FIG. 9b shows an object diagram and documentation related to the Transaction Information Storage of the present invention. XCTransactionVars 905 contains pointers to numerous other classes and allows for the passing of multiple objects in a single variable. XCTransactionInfo 906 contains information on a submitted transaction, and contains a list of transaction parameters, such as: success/failure, transaction number, transaction identifier, user name/password, and destination application, and also contains a linked list to the XCToolsMessages belonging to a particular transaction. XCBufferList 907 is a collection class for XCBuffer objects that is used by the XCStatedTxn 909 class objects as well as in User Exits. XCTransactionList 908 is a collection of XCToolsMessage 901 classes that contains the buffers associated with a transaction. XCStatedTxnList 909 is a collection class for XCStatedTxn 910 objects XCStatedTxn 910 is an information storage class, used to store states between change transactions. Relevant buffers are stored in this class 910, and are looked up when needed. This storage of transactions can expire after inactivity. XCApErrorHandler 911 is a collection class for error messages. Depending on the severity of the error being added to the system, XCAppErrorHandler 911 will either trigger an immediate exit of a function or will stack the errors so that they can be sent out in groups, using XCErrInfo, for internal storage of an error when stacking errors, 912 and error_severity 913.

FIG. 9c depicts the object diagram and description of the Transaction Registration Routines of the present embodiment of the invention. XCTransRegServer 914 maintains a list of available transactions, as well as open shared libraries. Containing registration functions for registering a shared library (RegisterLibrary) and the transactions within that shared library (RegisterTransaction), XCTransRegServer 914 also contains a function for locating a particular registered transaction (FindTransaction). XCTransRegTransaction 915 structure holds information on a particular transaction and contains a pointer to the parent shared library, a transaction number, and a pointer to the transaction function. The XCTransRegLibrary 916 structure holds information on a shared library containing transactions and stores description information as well as a pointer to the shared library.

FIGS. 9d-1 and 9d-2 depicts an object diagram and documentation for the Application Interface Class. XCAppInterface 917 class is the main class for the system in the present embodiment. Containing the applications, the XCAppInterface 917 includes the following functions: CreateDataBuffer, which takes string data and forms a buffer; CreateDynamicBuffer, which creates a dynamic buffer based on a given criteria; CreateBuffer, which creates a predifined buffer; StatedTxnCleanupThread, which cleans up stated transaction threads; StatedTxnList, which provides a list of stated transactions; AddTxn, which adds transaction formulation; DelTxn, which deletes transaction formulation; TransResponse, which formulates a transaction response; TransResponseMsg, which formulates a transaction response message; AdminMsg, which formulates an administration message; GetSysValue, which looks up system values; GetLiteral, which looks up literal values; TriggerUserExit, which provides user exit functionality, StartLogging, which starts the logging facility; StopLogging, which stops the logging facility; and ToolsTrace, which sends a tracing message.

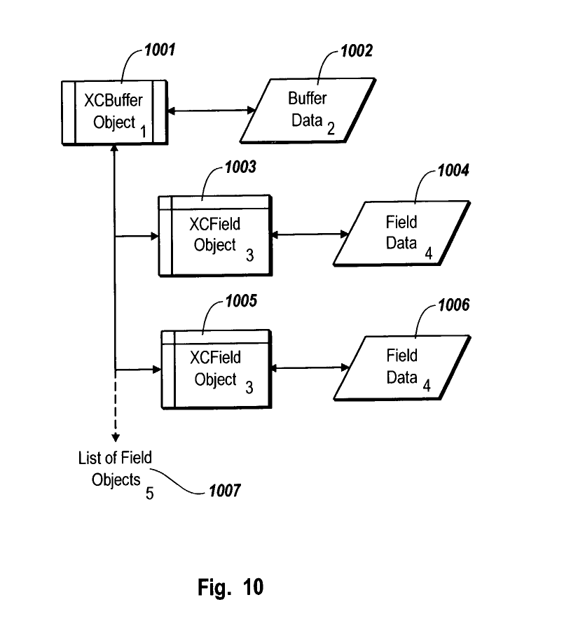

FIG. 10 shows a diagram of the classes and memory structures that are used to contain customizable data definitions of the present embodiment of the invention. XCBuffer object 1001 is an instantiation of the XCBuffer class in the process of this invention. This 1001 object represents a single data structure and contains Buffer Data 1002 for describing the object representation. Buffer Data 1002 is the buffer data associated with an instantiation of a XCBuffer class object. This Buffer Data 1002 includes information including a list of field objects 1007, the format number and the type of format associated with the buffer. The XCField Object 1003 is an instantiation of the XCField class in the process of this invention. This XCField Object 1003 represents a single data field and contains Field Data 1004 which describes the field object representation. The XCField Object 1005 is a second instantiation of the XCField class in the process of this invention. This XCField Object 1005 represents a single data field and contains the second Field Data 1006 which describes the field object representation. While this FIG. 10 shows only a first and second XCField Object 1003, 1005 and associated field data 1004, 1006, it is exemplary only and the invention is not so limited. In a number of envisioned embodiments of this invention, the number of these elements 1003, 1004, 1005, 1006 may be substantially larger or smaller.

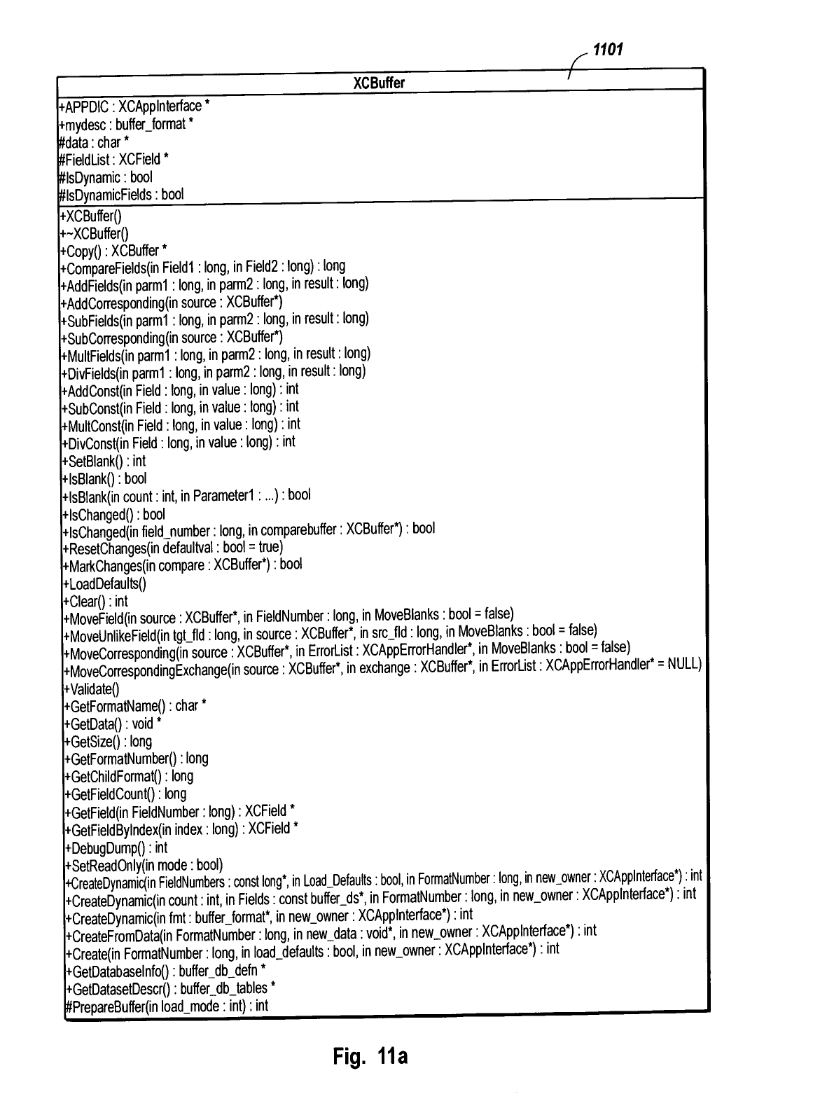

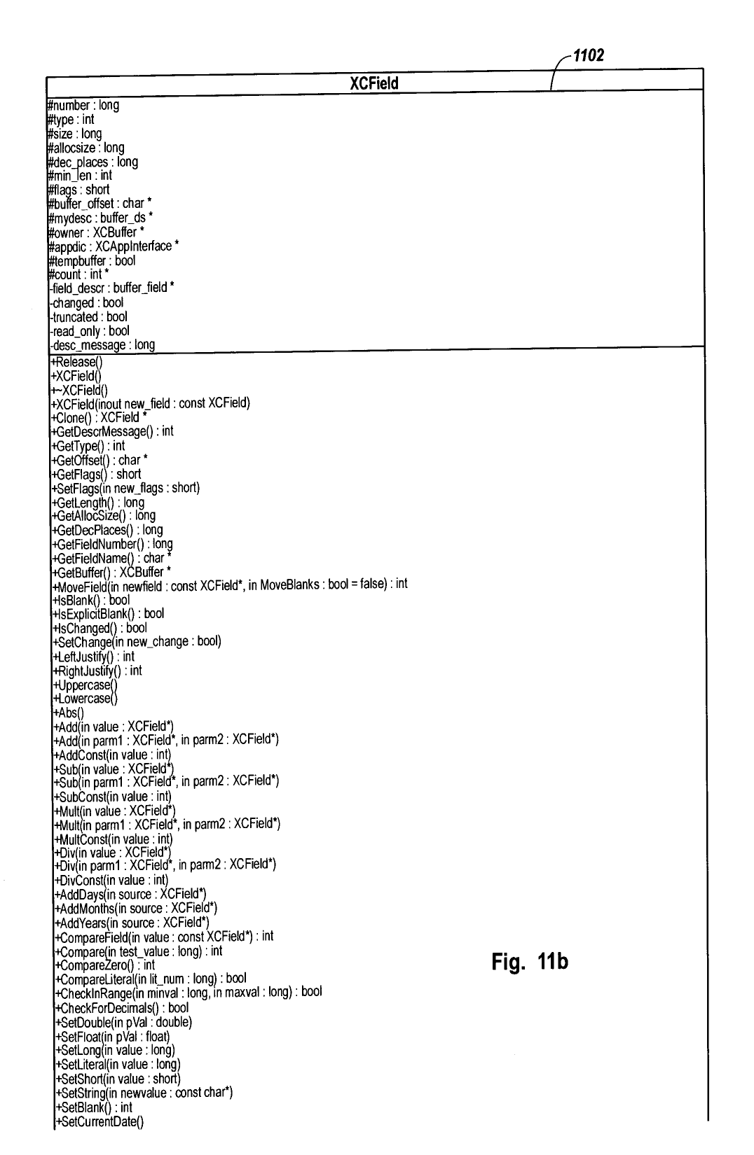

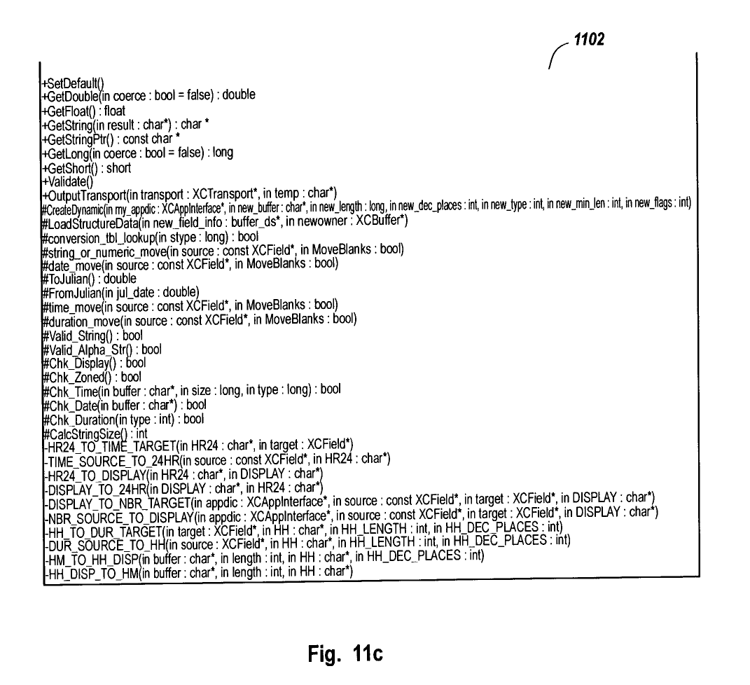

FIGS. 11a and 11b depict the object diagram and documentation for the Buffer Management and Fields Class. XCBuffer 1101 class is a container of XCField 1102 class objects, which owns the actual data for all of the XCField objects. The XCBuffer 1101 class also contains methods for operating on fields containing in the buffer. These methods include, but are not limited to the following: Mathematical operations against other fields in the buffer, including addition, subtraction, multiplication and division; Mathematical operations against other buffers, including addition and subtraction of matching fields in two buffers; Locating fields in a buffer; Comparisons between two fields; Comparisons against another buffer; Setting field values to defaults; Data movement between buffers, including fields with the same name (MoveField), fields with unlike names (MoveUnlikeField); all matching fields between the two buffers (MoveCorresponding); and all fields that match an “exchange” buffer (MoveCorrespondingExchange). The provided data movement between buffers is extremely powerful. It allows the end-user to customize fields onto a screen and to have those fields propagated through the existing transaction logic. The existing application need not necessarily “know” about the fields, as it is all handled by the eXsyst Anywhere libraries. The data movement works by calling the MoveField function on each of the matching fields in the buffer. The XCField 1102 class contains methods for operating on a particular field value. The XCField 1102 methods include: mathematical operations for use on constants or other fields, such as addition/subtraction, multiplication/division, abs, and year/day/month addition; comparison operations, such as compare to another field/compare to a literal value, and compare to zero; data movement, such as MoveField, function; and upper/lowercasing and left/right justification of data (strings). These functions provide methods to automatically convert the data from one type to another, allow the user to move data between fields/buffers without knowing what type of data is contained in those fields, abstracts the application from the data, and often used in the present embodiment of XCBuffer::MoveCorresponding set of functions.

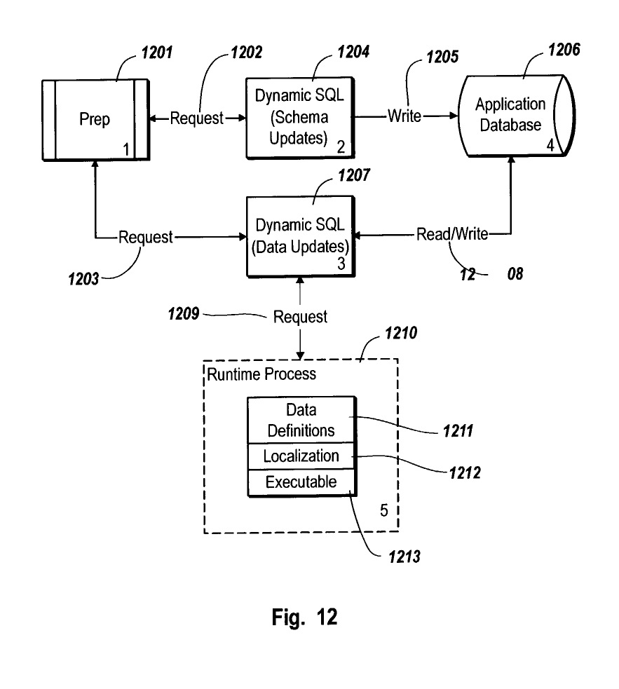

FIG. 12 shows a diagram that shows how the present dynamic SQL Generator is used based on current data definitions or customization data definition changes. The dynamic SQL statements are presently and typically generated by software libraries built to SQL 92 standards, with the database drivers built to handle specific database interfaces for different databases. Prep 1201 is an executing Prep Process 415 interacting with the application database 1206 through Schema Updates 1204 and or Data Updates 1207, via requests 1202, 1203 and writes 1205 or read/write 1208 operations. Schema Updates 1204 are performed if the customization requires that a database change is made to tables, fields, or keys. If significant changes are made to the database schema, then new tables may need to be created. In such a case, Prep 1201 performs a Data Update 1207 by copying data from the old table to the new customized table. The Dynamic SQL (Schema Updates) 1204 is the library responsible for creating SQL statements that modify the database schema (structure). This is accomplished, in the present embodiment of this invention, through generating SQL 92 statements and performing those statements on the Application Database 1206 through database drivers specific to the database vendor. The Dynamic SQL (Data Updates) 1207 is a library responsible for create SQL statements that modify existing database data, through inserting new data, by inserting new data, updating existing data, deleting existing data or retrieving existing data. In the present embodiment of this invention, this is accomplished through the generation of SQL 92 statements and performing those statements on the Application Database 1206 through database drivers specific to the database vendor. The Application Database 1206 is the software implementation of a database used by an application in this invention. This database 1206 can be selected to be any standard database types or database vendors for which a driver has been written. The runtime process 1210 communicates with the data updates 1207 via a data request 1209. This runtime process object is the runtime process of the customizable application, with requests made to the dynamic SQL library responsible for Data Updates 1207, and has data definitions 1211, localization 1212 and is executable code 1213.

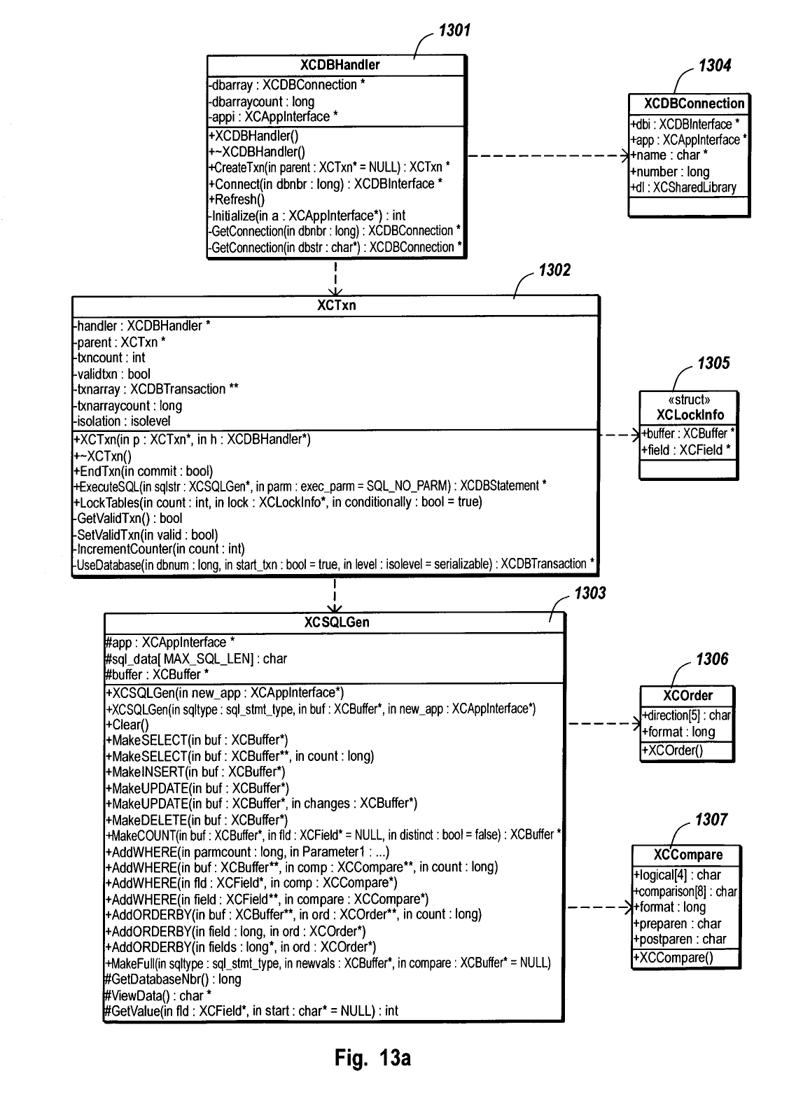

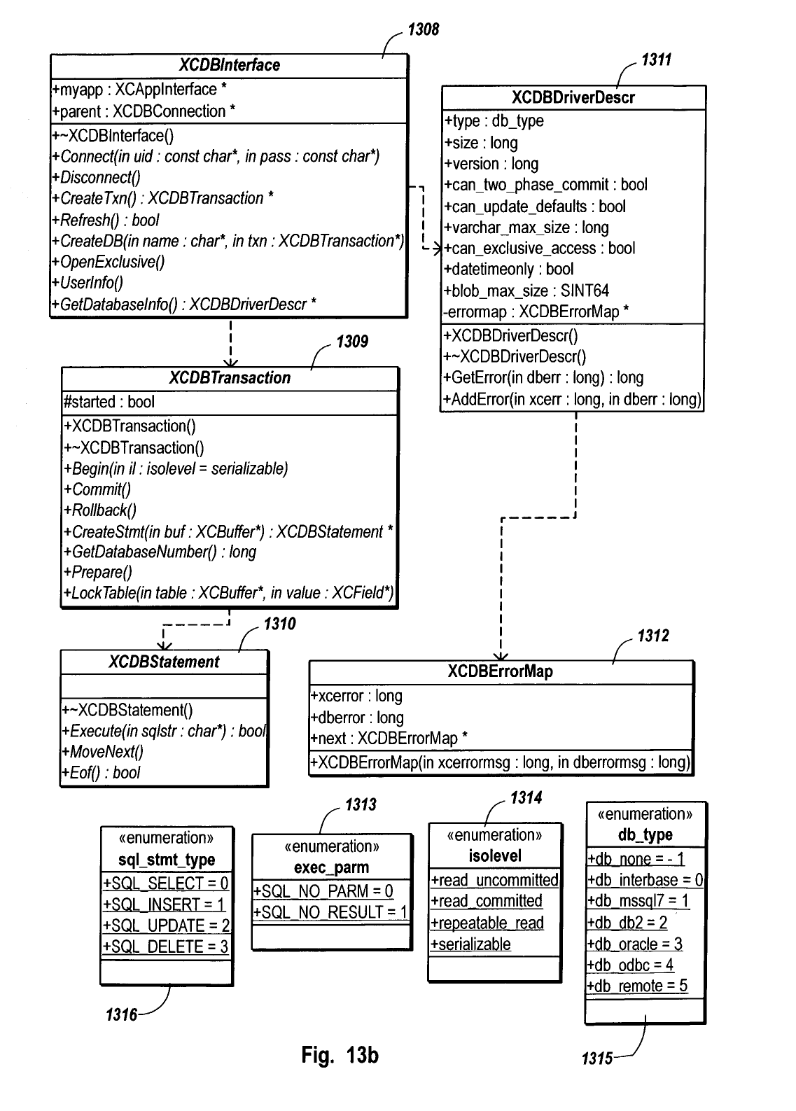

FIG. 13a is an object diagram and documentation of the Database Manipulation Routines. XCDBHandler 1301 class maintains a list of open database connections and provides functions to connect to a database, refresh (close/reopen) a connection and to create a transaction from the driver, returning an XCTxn object. The XCDBConnection 1304 class maintains information on a particular database connection and includes a pointer to the XCDBInterface 1308 (FIG. 13b) class for that driver, as well as the connection name, number and the shared library containing the database driver. XCTxn 1302 provides a database independent method for handling transactions, and allows execution of a provided SQL statement (through the XCSQLGen 1303 class). The XCTxn 1302 also supports nesting of transactions and will, in the present embodiment, handle two-phase commit logic. The LockTables function allows the locking of particular records or tables, in a database independent mode. XCLockInfo 1305 structure holds information used in locking tables. XCSQLGen 1303 class provides dynamic creation of SQL statements and provides functions to dynamically generate the following SQL statements: Select (as well as Select Count); Insert; Update; and Delete. XCSQLGen 1303 also provides functionality to add search criteria and sorting options through the AddWhere and AddORDERBY functions. XCOrder 1306 allows specification of parameters to be used in the AddORDERBY functions, and presently includes only the direction ASC or DESC. XCCompare 1307 allows the specification of parameters to be used in the AddWHERE functions and includes information such as the comparison type, the parenthesis placement, etc.

FIG. 13b depicts an object diagram and documentation for the Database Driver Design. XCDBInterface 1308 is the main interface class for a driver and contains functions to Connect/Disconnect from a database. The XCDBDriverDescr 1311 class contains descriptive information for a particular database driver and tells the system what features a database supports, such as: two phase commit support; ability to update default values; maximum varchar size; and allows exclusive access to the database. XCDBErrorMap 1312 provides information on mapping database specific errors to eXsyst Anywhere errors. This error information is stored in XCDBDriverDescr 1311. XCDBTransaction 1309 class implements transactions for the driver and contains functions to begin, commit, and/or rollback a transaction, as well as to create statements under that transaction. XCDBStatement 1310 class implements statements for the driver and contains functions to execute an SQL query against the database and to navigate the resulting result set. Enumerations of sql_stmt_type 1316, exec_parm 1313, isolevel 1314, and db_type 1315 are shown.

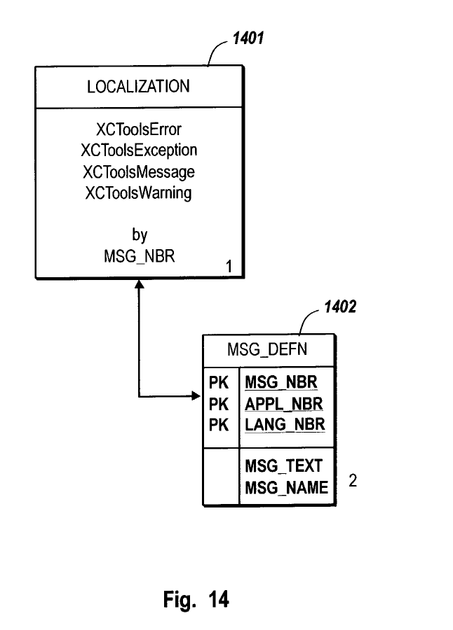

FIG. 14 shows a diagram that shows the relationship between the messages contained in the present APPDIC with the internal invention process structures for handling messages. The LOCALIZATION object 1401 provides the internal structures for handling application messages. The included classes are XCToolsError, XCToolsException, XCToolsMessage and XCToolsWarning. Each of these classes contains a data field named MSG_NBR, which contains the message number for a particular exception, error, message or warning. This message number is used to index into the MSG_DEFN table to retrieve the localized message. MSG_DEFN 1402 is a copy of the APPDIC MSG_DEFN table, as loaded into memory from the runtime APPDIC file that is generated by the Prep Process 415. This table definition includes a message number (MSG_NBR), an application number (APPL_NBR), and a language number (LANG_NBR) as the primary key (unique record) to access the records contained in this table. Also, associated with each record in the table is the localized message text (MSG_TEXT) along with a message name (MSG_NAME) used by the Makehfile utility to assist in application transaction coding by an application developer. At runtime of an application, a localized message can be retrieved using the LOCALIZATION 1401 classes by combining the message number from the application transaction code 303 and the application number and the language number from the submitted XML Transaction 1602.

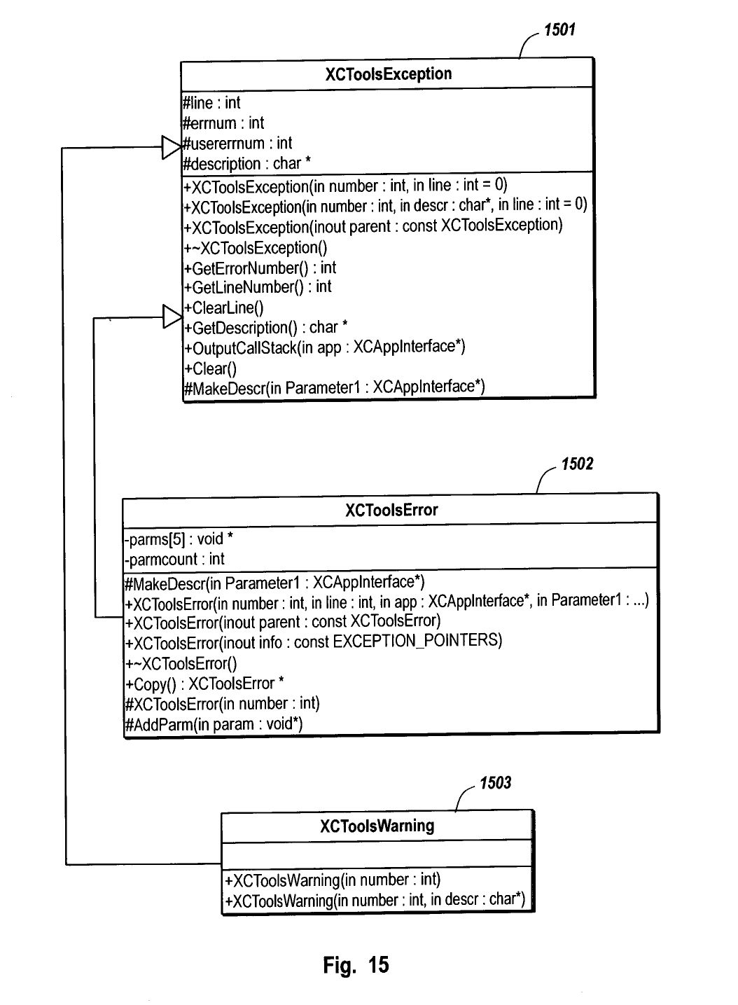

FIG. 15 depicts the object diagram and documentation for the Exception Handling Classes. The library uses exceptions to signal errors. The exceptions are based on the XCToolsException 1501 class, while the XCToolsError 1502 and the XCToolsWarning 1503 classes are derived from the XCToolsException 1501.

FIG. 16 shows a diagram showing the relationship between user interfaces, the Traffic Control System and the runtime process Applications, which in the present embodiment of the invention uses an XML Interface Server 1604. The User Interfaces 1601a,b represent an end-user interacting with an application program through the use of Application Transactions formatted, in this embodiment, as an XML Interface Transaction. The User Interfaces 1601a,b is selected to be any of the types of interface that can format data as XML transactions. These User Interfaces 1601a,b can be a GUI client, a web browser, a VT100 terminal interface, an inter-application interface using the XML Transaction format, or the like. Multiple connections 1603 from User Interfaces 1601a,b represent the ability of multiple user interfaces to connect through a single XML Interface Server 1604, via Generic Data Transfer Functions 602 to submit an XML Transaction 1602. Because of the use of multiple XML Interface Servers, there is essentially no connection limit as to the number of user interfaces that can interact with the system of this invention. The XML Interface Server 1604 is a multi-threaded process that acts as an interface server receiving and replying with XML formatted transactions. When a User Interface 1601a,b sends an XML Transaction 1602 to the XML Interface Server 1604, the XML Interface Server 1604 checks to see if it currently has a Transaction Communication 1607 to the requested Application Process 1609a,b. If not, the XML Interface Server 1604 queries the Grand Central Station (GCS) 1606, via the initial connect 1605 for an Application 1609a,b process to connect to. GCS 1606 directs, via the initial connect 1608, the requested Application Processes 1609a,b to connect directly, via transaction communication 1607, to the XML Interface Server 1604 for further transaction communication. The XML Interface Server 1604 then drops the Initial Connect 1605. The XML Interface Server 1604 then continues to pass XML transactions through to an Application Process 1609a,b. The GCS 1606 is the Grand Central Station process of the Traffic Control System 410. This process is a central point for connection and redirection of transactions. The Applications 1609a,b are customizable Application processes, which interact with the GCS 1606 and an XML Interface Server 1604. The multiple connections 1610 to Applications 1609a,b is shown to indicate that multiple Application processes 1609a,b can be executing in the system of this invention, and through the use of multiple computers and the Subsystem object 1704a,b in the Traffic Control System 410, there is essentially no connection limit as to the number of Applications 1609a,b that can interact with the system of this invention.

FIG. 17 shows a block diagram showing the tools layer of the present embodiment of the invention. This figure shows the GCS 1606 routing data between a first tools component 1701a, a second tools component 1701b with the first substation 1704a and the second substation 1704b. The first 1701a and second 1701b tools components each include a tools library 1702a,b and an interface handler 1703a,b. The tools libraries 1702a,b are shown in communication with a third 1706a and forth 1706b tools library, each of which works with an application handler 1705a,b and a database handler 1707a,b.

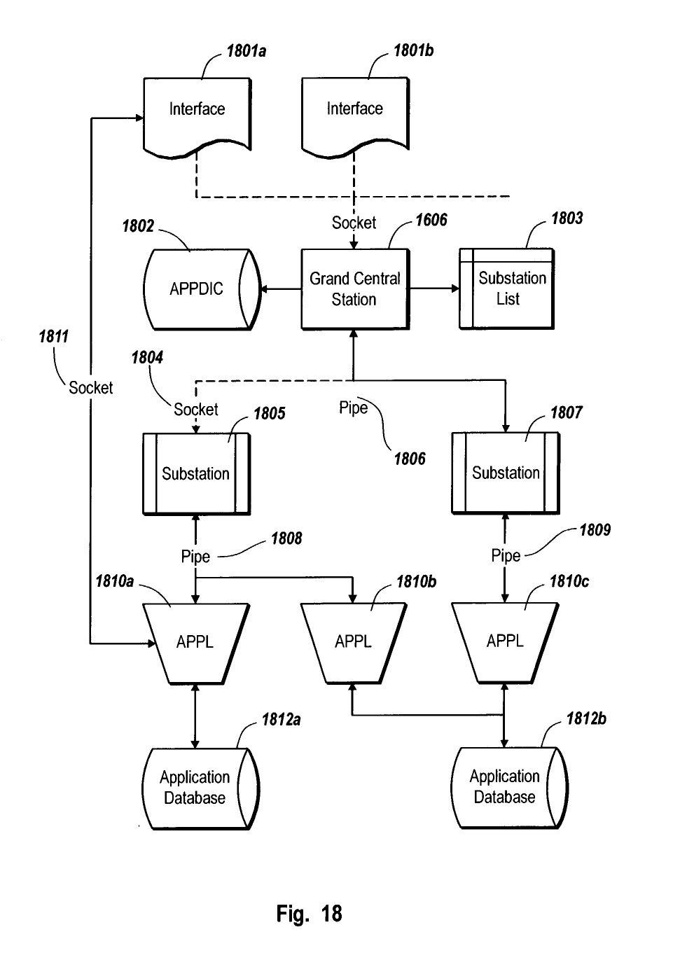

FIG. 18 shows a flow diagram of the present Traffic Control System 410 of the invention. Interfaces 1801a,b are provided to enable a user to access the Application programs 1810a,b,c. The routing of information through this Traffic Control System 410 is accomplished through the Grand Central Station (GCS) 1606, which accesses the APPDIC 1802 and the substation list 1803 and routes data via pipes 1806, 1808, 1809 and sockets 1804, 1811 to Substations 1805, 1807 and thereby to one or more Applications 1810a,b,c, each of which has or shares an Application Database 1812a,b.

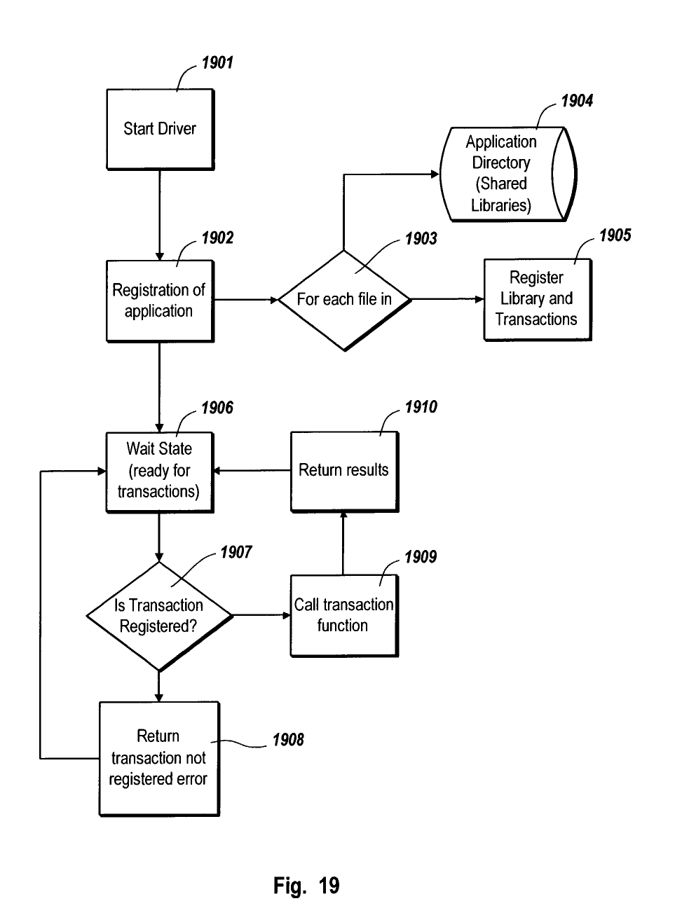

FIG. 19 is a flow diagram of the present method of the Application Handler. Initially the driver is started 1901. The application is registered 1902 for each file 1903 in either the application directory 1904 for shared libraries, or otherwise the library and transactions are registered 1905. The process waits 1906 in a ready state of transactions state. Upon receipt of a transaction, a test 1907 is made to determine if the transaction is registered. If the transaction is not registered, a transaction not registered error is returned 1908. If the transaction is registered then the transaction function is called 1909. Results are returned 1910 and the process returns to the wait state 1906. The XCTransRegServer 914 dynamically loads application shared libraries and registers each function within the shared library in a hash table for easy lookup. When transaction calls are received from the traffic system, the XCTransRegServer 914 searches the hash table for a corresponding transaction number and execute the transaction if possible. If the transaction is not found, an error is returned.

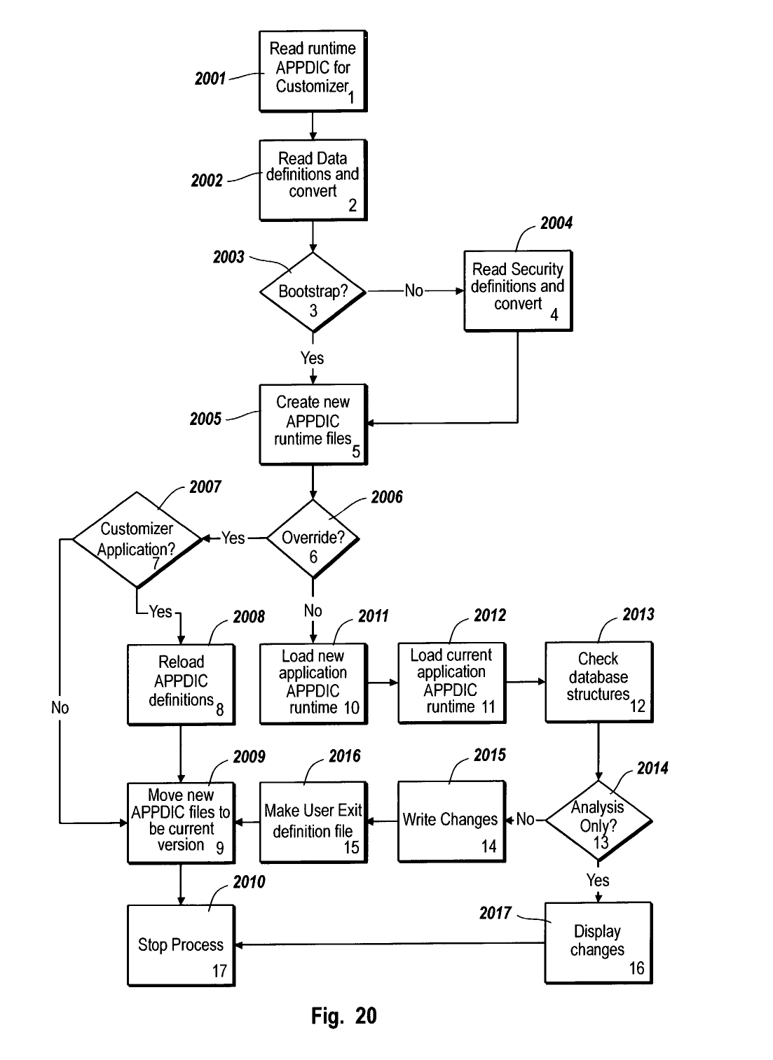

FIG. 20 shows a flow diagram of the Prep Process 415 of the present embodiment of the invention. The Prep Process 415 prepares an application for execution and makes necessary database changes. This Prep Process 415 receives as input an application number; a set of flags, including Bootstrap, Override and Analysis Only; an APPDIC runtime file and APPDIC database information, and outputs an APPDIC runtime file, database changes, and the user exit definition. Initially, the runtime APPDIC for Customizer is read 2001 in order to access the APPDIC database for the particular application that is to be prepared. The APPDIC database is opened and read 2002 in order to access various tables and conversion of the data to runtime information in memory. A test 2003 is made to determine if bootstrapping is being done. Generally, this flag is only useful for developing the APPDIC definitions for customizer. If no bootstrapping, then security information is read and converted 2004 to runtime memory. New APPDIC runtime files are created 2005 based on the information in memory. A second test 2006 is made to determine of it is desirable to override changes in the database. Generally, this flag is used by the application developer. If override is true, then a third test 2007 is made to determine if the customizer application is being developed. If the customizer application is being prepared, then the APPDIC definitions are reloaded 2008, to flush the current definition of APPDIC for customizer and load the newly created version. New APPDIC files are moved 2009 to the current version, archiving the old version. The user exit definition file is also moved if necessary. Next, the process of Prep 415 is stopped 2010. If override is not selected, then the new APPDIC runtime information is loaded 2011. The current application APPDIC runtime is loaded 2012. Database structures are checked 2013 to mark all necessary database changes. A fourth test 2014 is made to determine if database changes are desired. If a list of database changes is all that is desirable, then the necessary changes are displayed 2017 and the process stops 2010. If it is desired to actually make the necessary changes, the new APPDIC runtime information is written 2015 to a file from memory. A new user exit definition is created 2016 and the process continues with step 2009, as described above.

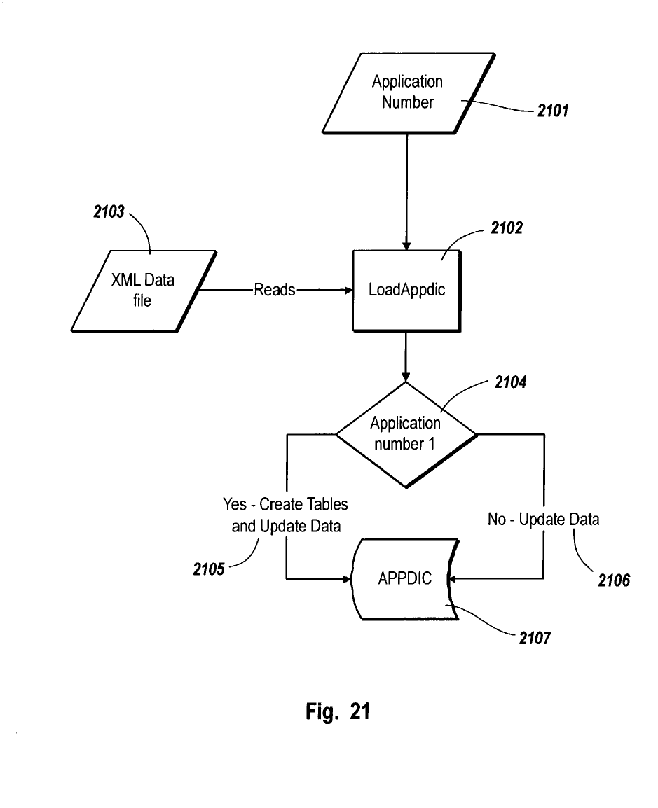

FIG. 21 shows a flow chart of the present load application process of this invention. The load application process is the process which loads xml information into the appdic database. The application number and an xml file is input. If the application number, in the present embodiment, is 1 (“customizer”), this load application process will actually create the appdic tables within the database. The application number 2101 is received. The application is loaded 2102 by reading the xml data file 2103. A test 2104 is made to determine if the application number is equal to 1. If the application number is equal to 1, create tables and update data 2105 in the application dictionary 2107 for the customizer/appdic. If the application number is not equal to 1, update data 2106 in the application dictionary 2107.

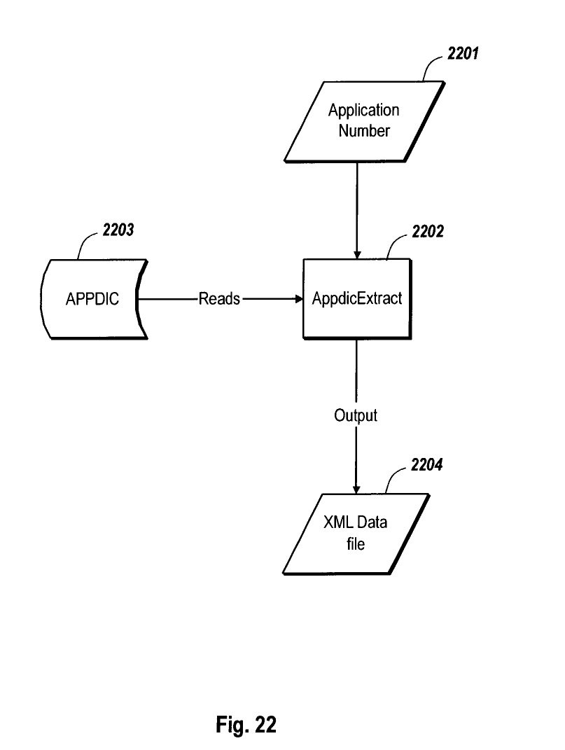

FIG. 22 provides a flow diagram of the appdic extraction process of the present embodiment of this invention. The appdic extraction process is the process which creates an xml transfer file from information in the appdic database. This process takes an application number as input and outputs an xml file with all relevant required application information. The application number 2201 is received. The appdic is extracted 2202 by reading the data from the appdic 2203. The xml data file 2204 is output.

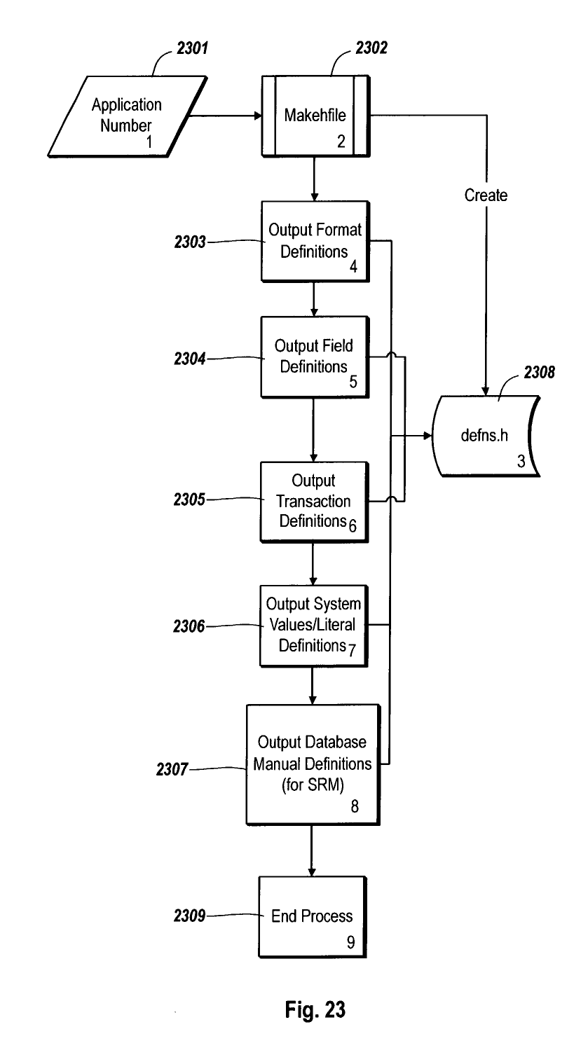

FIG. 23 shows a more detailed process flow diagram of the Makehfile utility process of this invention. The Application Number is received 2301 as input into the Makehfile process. The Makehfile process 2302 executed, which creates defns.h 2308. After Makehfile 2302 the format definitions are outputted 2303, the field definitions are outputted 2304, the transaction definitions are outputted 2305, the system values/literal definitions are outputted 2306 and the database manual definitions, for SRM, are outputted 2307. Then this process ends 2309.

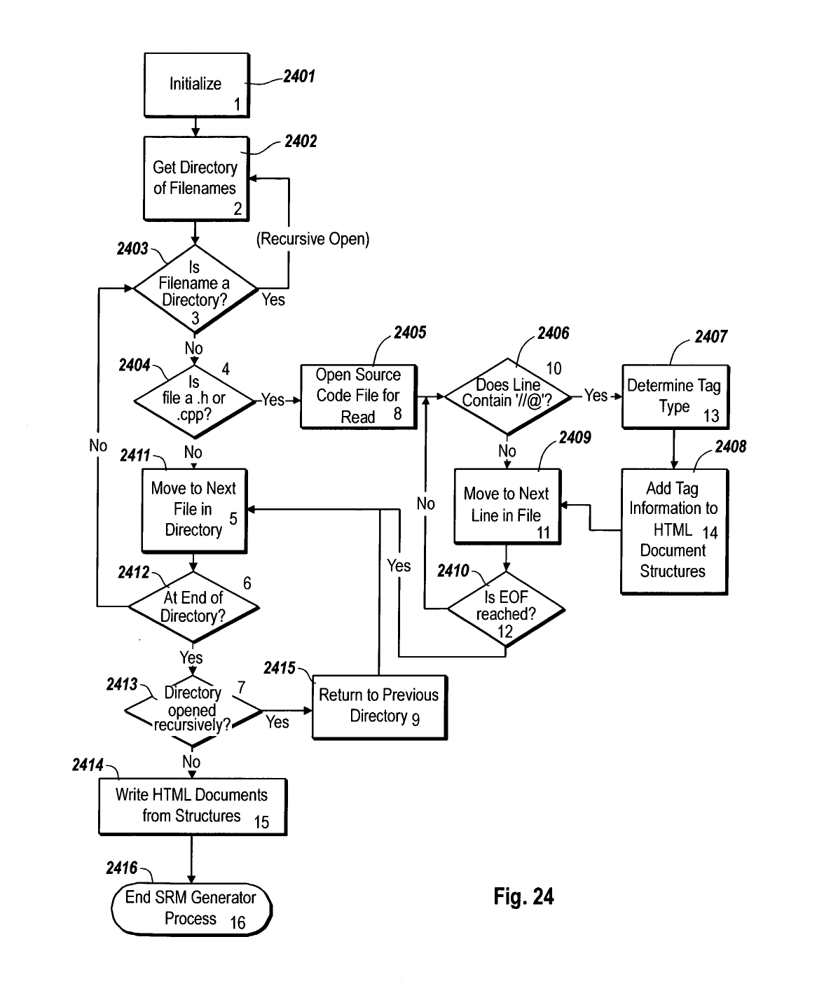

FIG. 24 shows a detailed flow diagram of the SRM (system reference manual) Generator utility process of the present embodiment of this invention. The process is initialized 2401, after which a directory of filenames is acquired 2402. A test 2403 is made to determine if the filename is a directory. If it is a directory, then the process returns to step 2402 through a recursive call to open the new directory. If the filename is not a directory, then a second test 2404 is made to determine if the file is a file with a .h or a .cpp file extension. If it is such a file, the source code file is opened and a single line is read 2405. A third test 2406 is made to determine if the line contains “//@”. If the third test 2406 is true, then the tag type is determined 2407 and the tag information is added to HTML document structures and the next line of the file is read 2409. A fourth test 2410 is made to determine if EOF has been reached. If the fourth test 2410 is false, then the process returns to step 2406, otherwise the process moves 2411 to the next file in the directory. A fifth test 2412 is made to determine if the process is at the end of the directory. If the fifth test is false 2412, then the process returns to step 2403. If the fifth test 2412 is true then a sixth text 2413 is made to learn if the directory was opened recursively. If the sixth test 2413 is true, then the process returns 2415 to the previous directory and goes to step 2411. Otherwise, the HTML documents are written 2414 from the HTML Document structures and the SRM generator process ends 2416.

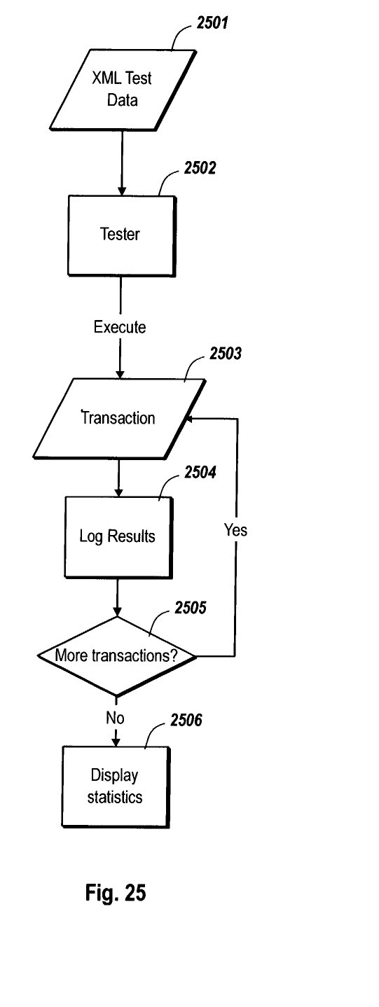

FIG. 25 depicts the present process of the tester. The tester process, of the present embodiment of the invention, is an automated testing process which takes a file of xml tests and continually submits transactions to the traffic system. Statistics on transactions, such as success or failure, return values, etc, are recorded. Xml text data is received 2501. The tester is called 2502, which is executed. When a transaction is received 2503, results of the tester is logged 2504. A test is made 2505 is made to determine if additional transactions remain. If yes, the process returns to the receipt of another transaction 2503. If no transactions remain, statistics are displayed 2506.

It is to be understood that the above described and referenced embodiments and examples are merely illustrative of numerous and varied other embodiments and applications which may constitute applications of the principles of the invention. These example embodiments are not intended to be exhaustive or to limit the invention to the precise form, connection or choice of objects, computer language or modules disclosed herein as the present preferred embodiments. Obvious modifications or variations are possible and foreseeable in light of the above teachings. These embodiments of the invention were chosen and described to provide the best illustration of the principles of the invention and its practical application to thereby enable one of ordinary skill in the art to make and use the invention, without undue experimentation. Other embodiments may be readily devised by those skilled in the art without departing from the spirit or scope of this invention and it is our intent that they be deemed to be within the scope of this invention, as determined by the appended claims when they are interpreted in accordance with the breadth to which they are fairly, legally and equitably entitled.

1. A system for software development, comprising:
(A) one or more customization utilities;
(B) an application dictionary database;
(C) a preparation utility;
(D) a communication interface;
(E) an application database; and
(F) a routing system in communication with said one or more customization utilities, said application dictionary database, said preparation utility, said communication interface, said application database, and wherein said routing system provides a traffic control system between said one or more customization utilities, said application dictionary database, said preparation utility, said communication interface and said application database.

2. A system for software development, as recited in claim 1, wherein said customization utilities further comprises a transaction for adding information to said application dictionary database.

3. A system for software development, as recited in claim 1, wherein said customization utilities further comprises a transaction that modifies the information stored in said application dictionary database.

4. A system for software development, as recited in claim 1, wherein said application dictionary database further comprises a database containing definitions of data elements, buffers, literals, messages, tables, and data structures.

5. A system for software development, as recited in claim 1, wherein said preparation utility reads said application dictionary, builds an appdic runtime file, user exit definitions, and makes changes to said application database as necessary.

6. A system for software development, as recited in claim 1, wherein said communication interface is selected from the group consisting of an interface server for a web site, an interface server for a terminal, an interface for a graphical user interface, a user interface, an application program interface, a report writer, and an application-to-application interface.

7. A system for software development, as recited in claim 1, wherein said traffic control system further comprises one or more substations and a grand central station that passes information through said substation to contact an interface on a specified port.

8. A method for software development, comprising:
(A) developing customizable computer application programs using a library of functions;
(B) communicating between an application dictionary database and a customizer utility;
(C) reading from said application dictionary database;
(D) building a runtime environment for said computer software;
(E) communicating between an application database and an SQL process;
(F) communicating between said runtime environment and said SQL process;
(G) controlling data traffic between an application dictionary file and an interface; and
(H) interfacing between an electronic device and said application dictionary.

9. A method for software development, as recited in claim 8, wherein said customization further comprises facilitating the operation of computer code on a variety of computer operating systems without modification of the original source code.

10. A system for software development, comprising:
(A) a computer device comprising:
(i) a processor;
(ii) an input device in communication with said processor;
(iii) a display device in communication with said processor; and
(iv) a network interface device; and
(B) a software customization program executed on said processor, wherein said software customization program comprises:
(i) a customizer;
(ii) an application dictionary database receiving data definition information from said customizer;
(iii) a preparation process compiling changes implemented by said customizer and managing changes to said application dictionary database.
